(19) United States
(12) Patent Application Publication
(10) Pub. No.: US 2022/0395881 A1
(43) Pub. Date: Dec. 15, 2022

(54) COOLING DEVICE AND COOLING METHOD

(71) Applicant: NIPPON STEEL CORPORATION, Tokyo (JP)

(72) Inventors: Atsushi TOMIZAWA, Komatsu (JP); Kazuo UEMATSU, Tokyo (JP)

(73) Assignee: NIPPON STEEL CORPORATION, Tokyo (JP)

(21) Appl. No.: 17/779,060

(22) PCT Filed: Feb. 22, 2021
(86) PCT No.: PCT/JP2021/006525

§ 371 Date: May 23, 2022

(30) Foreign Application Priority Data
Feb. 27, 2020 (JP) 2020-032058

(51) Int. Cl. B21D 7/16

(52) U.S. Cl. CPC B21D 7/165; B21D 7/162

(57) ABSTRACT

This cooling device includes a first cooling mechanism and a second cooling mechanism. The first cooling mechanism includes a first nozzle disposed to be aligned with a heating coil on a downstream side and whose injection direction of a refrigerant is a first injection direction, a second nozzle disposed to be aligned with the first nozzle on a downstream side and whose injection direction of the refrigerant is a second injection direction intersecting the first injection direction, a first valve selectively switching a supply destination of the refrigerant between one and the other of the first nozzle and the second nozzle, and a first control unit controlling the first valve. The second cooling mechanism includes a third nozzle disposed on a side opposite to the first nozzle and the second nozzle with the extension line sandwiched therebetween and whose injection direction of the refrigerant is a third injection direction forming an angle of 20 degrees or more and 70 degrees or less with respect to a bent inner circumferential surface of a bent portion.

### TECHNICAL FIELD

The present invention relates to a cooling device and a cooling method.

Priority is claimed on Japanese Patent Application No. 2020-032058, filed Feb. 27, 2020, the content of which is incorporated herein by reference.

### BACKGROUND ART

As is well known, a strength member, a reinforcing member, or a structural member made of a metal with a hollow bent shape used in automobiles, various machines, and so on is required to be lightweight and have a high strength. Conventionally, this type of hollow bent part has been manufactured by, for example, cold bending processing, welding of a press-processed product, punching of a thick plate, forging, and the like. However, there has been a limit to weight reduction and increase in strength of the hollow bent part manufactured by those manufacturing methods, and realization thereof has not been easy.

In recent years, for example, as disclosed in Non Patent Document 1, it has been actively studied to manufacture this type of hollow bent part by a so-called tube hydroforming method. However, as described on page 28 of Non Patent Document 1, the tube hydroforming method has problems such as development of a material to be used as a material thereof and improvement of formability, and thus further development is required in the future.

In view of such a current state, the present inventors have previously disclosed an invention relating to a bending processing apparatus by Patent Document 1. FIG. 15 is an explanatory view schematically illustrating an outline of a bending processing apparatus 100.

As illustrated in FIG. 15, in the bending apparatus 100, a hollow bent part Pp made of a steel is manufactured by performing bending processing on a steel pipe (hereinafter referred to as hollow material Pm) supported to be movable in an axial direction thereof by a pair of support means 101 and 101 at a downstream position of the support means 101 and 101 while feeding the steel pipe from an upstream side toward a downstream side in an arrow F direction by a feeding device (not illustrated). That is, the hollow material Pm is rapidly heated to a temperature range in which it can be partially quenched by a high-frequency heating coil 102 at the downstream position of the support means 101 and 101, and the hollow material Pm is rapidly cooled by a water cooling device 103 disposed downstream of the high-frequency heating coil 102. Then, the bending processing on the hollow material Pm is performed by changing a position of a movable roller die 104, which has at least one set of roll pairs 104a and 104a and feeds the hollow material Pm while supporting it, in directions in three dimensions (directions in two dimensions in some cases) and applying a bending moment to a heated part of the hollow material Pm. According to the bending processing apparatus 100, the high-strength hollow bent part Pp can be manufactured with high productivity.

### CITATION LIST

### Patent Document

### [Patent Document 1]

PCT International Publication No. WO 2006/093006

### [Patent Document 2]

PCT International Publication No. WO 2011/024741

### [Patent Document 3]

Japanese Patent (Granted) Publication No. 6015878

### Non Patent Document

### [Non Patent Document 1]

Journal of Society of Automotive Engineers of Japan Vol. 57, No. 6, 2003, pp. 23-28

### [Non Patent Document 2]

Tube Forming, Corona Publishing Co., Ltd., First edition, 3rd impression, Nov. 25, 2002, pp. 51-55

### SUMMARY OF THE INVENTION

### Problems to be Solved by the Invention

There are various shapes of hollow bent parts used in automobiles, various machines, and so on. Above all, there is a large number of hollow bent parts with an extremely small bent portion in which a bending radius of the bent portion is, for example, 1 to 2 times or less than a diameter (when a metal pipe has a rectangular cross section, a length of one side connecting a side edge of a bent inner circumferential surface and a side edge of a bent outer circumferential surface in a cross section perpendicular to a longitudinal direction thereof) of the metal pipe.

However, when bending processing is performed by the method of Patent Document 1 so that a bending radius is, for example, 1 to 2 times or less than a diameter (a length of one side when the metal pipe has a rectangular cross section) of the metal pipe, there is a likelihood that wrinkles or folds will occur on an inner circumferential side of the bent portion, or a plate thickness on an outer circumferential side of the bent portion will be significantly reduced and breakage will occur. Therefore, it has been difficult to manufacture a hollow bent part with a small bent portion.

Further, in cold bending processing of the hollow bent part, as described in Non Patent Document 2, since tensile stress acts on an outer circumferential side of the bent portion, a plate thickness is reduced. Since the method of Patent Document 1 is also of bending processing, it is unavoidable that a plate thickness on the outer circumferential side of the bent portion will be reduced.

Therefore, in order to solve these problems, the present inventors have disclosed an invention relating to a shearing and bending processing apparatus by Patent Document 2.

As illustrated in FIG. 16, a shearing and bending processing apparatus 200 includes a first support means 201, a heating means 202, a cooling means 203, and a gripping means 204. The first support means 201 supports a hollow material Pm made of a metal at a first position A while feeding the hollow material Pm relatively in a longitudinal direction thereof. The heating means 202 partially heats the hollow material Pm at a second position B downstream of the first position A in a feeding direction of the hollow material Pm. The cooling means 203 cools (forced cooling or natural cooling) a heated portion of the hollow material Pm at a third position C downstream of the second position B in the feeding direction of the hollow material Pm. The gripping means 204 applies a shearing force to the heated portion of the hollow material Pm by moving the hollow material Pm in directions in two dimensions or directions in three dimensions while positioning the hollow material Pm at a fourth position D downstream of the third position C in the feeding direction of the hollow material Pm. Therefore, according to the shearing and bending processing apparatus 200, it is possible to apply shearing processing and a heat treatment to the heated portion of the hollow material Pm. Further, according to the shearing and bending processing apparatus 200, it is possible to mass-produce high-strength hollow bent parts having a bent portion with a bending radius of 1 to 2 times or less than a diameter (a length of one side when the metal pipe has a rectangular cross section) of the metal pipe at low cost.

According to the invention of Patent Document 2, it has become possible to manufacture parts with high strength and a small bending radius, and the weight of mechanical parts including a large number of automobiles has been significantly reduced.

In the invention of Patent Document 2, uniform cooling in a circumferential direction and an axial direction is important to obtain a satisfactory product. Focusing on this uniform cooling, a cooling device for steel illustrated in FIG. 17 has been disclosed by Patent Document 3. This cooling device for steel is a cooling device that cools a heated part including a bend immediately after forming a predetermined shape including the bend by moving one end portion of a long steel Pm in directions in two dimensions or directions in three dimensions while heating a portion of the steel Pm in a longitudinal direction thereof while feeding the steel Pm in the longitudinal direction in a state in which the one end portion of the steel Pm is gripped, and the cooling device for steel includes a primary cooling device 22 that injects a first refrigerant onto the heated part, and a secondary cooling device 23 provided on a downstream side of the primary cooling device 22 when viewed in a feeding direction of the steel Pm and injecting a second refrigerant onto the heated part, in which a plurality of secondary cooling devices 23 are disposed in the feeding direction to be able to control a flow rate of the second refrigerant independently of each other, and include a plurality of cooling mechanisms disposed in a circumferential direction of the steel Pm and injecting the second refrigerant to be able to control a flow rate independently of each other.

According to the cooling device for steel described in Patent Document 3, it is possible to reduce non-uniformity of hardness of the bent steel Pm with a relatively large bending radius in the bending processing method illustrated in Patent Document 2. However, when the cooling device described in Patent Document 3 is applied to the shearing and bending processing described in Patent Document 2, further improvement for obtaining uniform cooling may be required depending on processing conditions.

That is, in a hollow bent part having a bent portion with an extremely small bending radius of 1 to 2 times or less than a diameter (a length of one side when the metal pipe has a rectangular cross section) of the metal pipe, there are cases in which a bending angle of the bent portion is close to a right angle. When a large bending angle is formed with such an extremely small bending radius, since a processing direction changes rapidly, simply changing a configuration of the secondary cooling device cannot deal with this. The reason for this is because there is a portion in which the refrigerant from the primary cooling device does not hit the bent portion immediately after the heating, or the refrigerant flows in a direction opposite to the feeding direction of the hollow material Pm. This problem is more likely to occur when the shearing and bending processing is performed than in normal bending processing.

When the shearing processing is performed, a region subjected to shear deformation is at a high temperature and flow stress is reduced. The primary cooling device is for cooling immediately after heating, and if sufficient and uniform cooling is not provided in a circumferential direction, flow stress of the deformed region becomes non-uniform in the circumferential direction. In this case, it is difficult to obtain satisfactory shear deformation. Also, hardness of the finished product also is non-uniform in the circumferential direction. Also, so-called uneven baking may occur.

The present invention has been made in view of the above circumstances and is directed to providing a cooling device and a cooling method capable of securing a collision pressure of the refrigerant to obtain a sufficient cooling capacity and enabling uniform cooling in which non-uniformity of hardness in a circumferential direction of the product is curbed even when obtaining a hollow bent part having a bent portion with an extremely small bending radius.

### Means for Solving the Problem

In order to solve the above-described problems and achieve the objective, the present invention adopts the following aspects.

(1) One aspect of the present invention is a cooling device which is used for a hollow bent part manufacturing apparatus including a feeding mechanism feeding a hollow material made of a metal in a feeding direction which is a longitudinal direction thereof while supporting the hollow material at a first position, a heating coil heating the hollow material at a second position downstream of the first position, a cooling device cooling the hollow material by injection of a refrigerant at a third position downstream of the second position, and a bending force applying part forming a bent portion in the hollow material by gripping the hollow material at a fourth position downstream of the third position and moving a gripping position in directions in two dimensions or directions in three dimensions, and the cooling device includes a first cooling mechanism and a second cooling mechanism, in which the first cooling mechanism includes a first nozzle disposed to be aligned with the heating coil on a downstream side when viewed in a first virtual plane including an extension line of an axis in the feeding direction of the hollow material at the first position and whose injection direction of the refrigerant is a first injection direction, a second nozzle disposed to be aligned with the first nozzle on a downstream side when viewed in the first virtual plane and whose injection direction of the refrigerant is a second injection direction intersecting the first injection direction, a first valve selectively switching a supply destination of the refrigerant between one and the other of the first nozzle and the second nozzle, and a first control unit controlling the first valve, and the second cooling mechanism includes a third nozzle disposed on a side opposite to the first nozzle and the second nozzle with the extension line sandwiched therebetween when viewed in the first virtual plane and whose injection direction of the refrigerant is a third injection direction forming an angle of 20 degrees or more and 70 degrees or less with respect to a bent inner circumferential surface of the bent portion.

(2) The following configuration may be adopted in the above-described (1). The second cooling mechanism includes a first part nozzle and a second part nozzle constituting the third nozzle, a second valve which selectively switches a supply destination of the refrigerant between one and the other of the first part nozzle and the second part nozzle, and a second control unit which controls the second valve, an injection direction of the refrigerant from the first part nozzle when viewed in the first virtual plane is 20 degrees or more and 70 degrees or less with respect to the extension line, and an injection direction of the refrigerant from the second part nozzle when viewed in the first virtual plane is the third injection direction.

(3) The following configuration may be adopted in the above-described (1) or (2). A third cooling mechanism including a fourth nozzle and a fifth nozzle which are disposed on a second virtual plane perpendicular to the first virtual plane with the extension line as a line of intersection is further provided, in which an injection direction of the refrigerant of the fourth nozzle when viewed in the first virtual plane is a fourth injection direction along the extension line, and an injection direction of the refrigerant of the fifth nozzle when viewed in the first virtual plane is a fifth injection direction which intersects the fourth injection direction.

(4) The following configuration may be adopted in the above-described (3). The third cooling mechanism further includes a third valve which selectively switches a supply destination of the refrigerant between one and the other of the fourth nozzle and the fifth nozzle, and a third control unit which controls the third valve.

(5) The following configuration may be adopted in any one of the above-described (1) to (4). A fourth cooling mechanism which includes a sixth nozzle disposed on the second virtual plane perpendicular to the first virtual plane with the extension line as a line of intersection is further provided, in which an injection direction of the sixth nozzle when viewed in the first virtual plane is a sixth injection direction which forms an angle of approximately ½ of a shear angle θ of the bent portion with respect to the feeding direction.

(6) Another aspect of the present invention is a cooling method which is used for a manufacturing method of a hollow bent part including a process of feeding a hollow material made of a metal in a feeding direction which is a longitudinal direction thereof while supporting the hollow material at a first position, a process of heating the hollow material at a second position downstream of the first position, a process of cooling the hollow material by injection of a refrigerant at a third position downstream of the second position, and a process of forming a bent portion in the hollow material by gripping the hollow material at a fourth position downstream of the third position and moving a gripping position in directions in two dimensions or directions in three dimensions, and the cooling method includes a first cooling process and a second cooling process, in which the first cooling process includes a first process of injecting the refrigerant from the third position in a first injection direction when viewed in a first virtual plane including an extension line of an axis in the feeding direction of the hollow material at the first position, a second process of injecting the refrigerant from the third position in a second injection direction intersecting the first injection direction when viewed in the first virtual plane, and a third process in which the second process is stopped when the first process is performed and the first process is stopped when the second process is performed, and, in the second cooling process, the refrigerant is injected from the third position in a third injection direction forming an angle of 20 degrees or more and 70 degrees or less with respect to a bent inner circumferential surface of the bent portion when viewed in the first virtual plane.

(7) The following configuration may be adopted in the above-described (6). The second cooling process includes a fourth process of injecting the refrigerant in an injection direction of 20 degrees or more and 70 degrees or less with respect to the extension line when viewed in the first virtual plane, a fifth process of injecting the refrigerant in the third injection direction when viewed in the first virtual plane, and a sixth process in which the fifth process is stopped when the fourth process is performed and the fourth process is stopped when the fifth process is performed.

(8) The following configuration may be adopted in the above-described (6) or (7). A third cooling process of injecting the refrigerant toward the hollow material from a fourth injection direction and a fifth injection direction in a second virtual plane perpendicular to the first virtual plane with the extension line as a line of intersection is further provided, in which the third cooling process includes a seventh process of injecting the refrigerant in the fourth injection direction along the extension line when viewed in the first virtual plane, and an eighth process of injecting the refrigerant in the fifth injection direction intersecting the fourth injection direction when viewed in the first virtual plane.

(9) The following configuration may be adopted in the above-described (8). The third cooling process further includes a ninth process in which the eighth process is stopped when the seventh process is performed and the seventh process is stopped when the eighth process is performed.

(10) The following configuration may be adopted in any one of the above-described (6) to (9). A fourth cooling process of injecting the refrigerant toward the hollow material in the second virtual plane perpendicular to the first virtual plane with the extension line as a line of intersection is further provided, in which the fourth cooling process includes a tenth process of injecting the refrigerant in a sixth injection direction in which an angle formed by an injection direction of the refrigerant with respect to the feeding direction when viewed in the first virtual plane is approximately ½ of a shear angle θ of the bent portion.

### Effects of the Invention

According to the cooling device and the cooling method according to the above-described aspects, it is possible to secure a collision pressure of the refrigerant to obtain a sufficient cooling capacity and achieve uniform cooling in which non-uniformity of hardness in a circumferential direction of the product is curbed even when obtaining a hollow bent part having a bent portion with an extremely small bending radius.

### BRIEF DESCRIPTION OF DRAWINGS

FIG. 1 is a plan view schematically illustrating a manufacturing apparatus including a cooling device according to one embodiment of the present invention.

FIG. 2 is a view illustrating a main part of the cooling device and is an enlarged plan view of the portion X in FIG. 1.

FIG. 3A is a view illustrating a conventional cooling method when a hollow material is fed without shearing and bending processing and is an enlarged plan view of a portion corresponding to the portion X in FIG. 1.

FIG. 3B is a view illustrating the conventional cooling method when the shearing and bending processing is performed on the hollow material and is an enlarged plan view of the portion corresponding to the portion X in FIG. 1.

FIG. 3C is an enlarged plan view of a portion corresponding to the portion X in FIG. 1 and illustrates a case in which an injection direction of a refrigerant is changed when the shearing and bending processing is performed on the hollow material.

FIG. 4A is a view illustrating the conventional cooling method when the hollow material is fed without the shearing and bending processing and is an enlarged plan view of a portion corresponding to the portion X in FIG. 1.

FIG. 4B is a view illustrating the conventional cooling method when the shearing and bending processing is performed on the hollow material and is an enlarged plan view of a portion corresponding to the portion X in FIG. 1.

FIG. 5A is a view illustrating a cooling method of the present embodiment when a hollow material is fed without the shearing and bending processing and is an enlarged plan view of the portion X in FIG. 1.

FIG. 5B is a view illustrating the cooling method of the present embodiment when the shearing and bending processing is performed on the hollow material and is an enlarged plan view of the portion X in FIG. 1.

FIG. 6A is a view illustrating a main part of the cooling device of the present embodiment and is a view along line P-P indicated by the arrows in FIG. 2.

FIG. 6B is a view illustrating a modified example of the embodiment and is a view corresponding to FIG. 6A.

FIG. 7 is a view illustrating a modified example of the embodiment and is an enlarged plan view illustrating a portion corresponding to the portion Q in FIG. 2.

FIG. 8 is a view illustrating a main part of the cooling device of the present embodiment and is a view along line Y1-Y1 indicated by the arrows in FIG. 2.

FIG. 9 is a view illustrating a cooling method of the cooling device and is an enlarged plan view of a shearing and bending processing portion of the hollow material from the arrow R of FIG. 8.

FIG. 10A is an enlarged plan view illustrating a case in which an upper surface of a shearing and bending processing portion of the hollow material is cooled by the conventional cooling method.

FIG. 10B is a view illustrating a case in which an upper surface of the shearing and bending processing portion of the hollow material is cooled by the cooling method of the present embodiment, and is an enlarged plan view corresponding to FIG. 10A.

FIG. 11 is a view illustrating a modified example of the cooling device of the present embodiment and is a view along line Y1-Y1 indicated by the arrows in FIG. 2.

FIG. 12 is a view illustrating the modified example and is a bottom view of the hollow material from the arrow U of FIG. 11.

FIG. 13 is a view illustrating the modified example of the present embodiment and is a view along line Y1-Y1 indicated by the arrows in FIG. 2.

FIG. 14A is a view illustrating a case in which the hollow material is fed without applying the shearing and bending processing in the modified example, and is an enlarged plan view from the arrow T of FIG. 13.

FIG. 14B is a view illustrating the hollow material when the shearing and bending processing is applied in the modified example and is an enlarged plan view from the arrow T of FIG. 13.

FIG. 15 is an explanatory view illustrating a schematic configuration of a conventional bending processing apparatus disclosed in Patent Document 1.

FIG. 16 is an explanatory view illustrating a schematic configuration of a conventional shearing and bending processing apparatus disclosed in Patent Document 2.

FIG. 17 is an explanatory view illustrating a schematic configuration of a conventional cooling device disclosed in Patent Document 3.

### EMBODIMENTS FOR IMPLEMENTING THE INVENTION

Hereinafter, one embodiment of the present invention and various modified examples thereof will be described with reference to the drawings. In the following description, a case in which a hollow bent part to be manufactured utilizes a hollow square pipe made of steel and having a rectangular cross-sectional shape as a material (hereinafter referred to as hollow material Pm) to manufacture a product (hereinafter referred to as a hollow bent part Pp) such as a strengthening part, a reinforcing part, or a structural part used in automobiles or various machines is exemplified. First, a manufacturing apparatus (hereinafter referred to as a manufacturing apparatus 10) for a hollow bent part will be described, and then a manufacturing method for a hollow bent part will be described. A cooling device according to the present embodiment is provided in the manufacturing apparatus 10.

Further, components common in the present embodiment and modified examples thereof may be denoted by the same reference signs and duplicate description thereof may be omitted.

### [Manufacturing Apparatus for Hollow Bent Part]

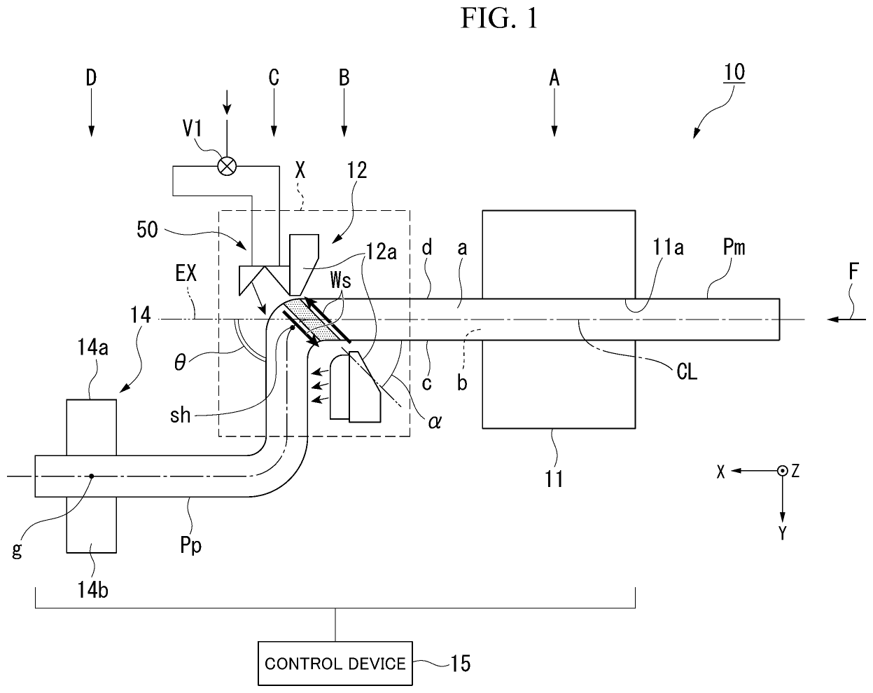

FIG. 1 is a plan view schematically illustrating the manufacturing apparatus 10 for a hollow bent part according to the present embodiment. Further, a cooling device of the present invention can perform both normal bending processing and shearing and bending processing, but in the following description, a case in which shearing and bending processing is performed will be exemplified. Here, regarding a term including both normal bending processing and shearing and bending processing (shearing processing), bending processing may simply be referred to.

The hollow bent part Pp is obtained by subjecting the hollow material Pm to the shearing and bending processing by the manufacturing apparatus 10. The hollow material Pm is a long square pipe with a closed cross-sectional shape whose cross section perpendicular to a longitudinal direction thereof is hollow and rectangular. Further, an object to be processed in the present embodiment is not limited to a square pipe, and the present embodiment can also be applied to, for example, a circular pipe, an elliptical pipe, and other steel pipes with different cross-sectional shapes of various types. Also, as the hollow material Pm with a rectangular cross section, either cross-sectional shape of a square shape or a rectangular shape is applicable. Furthermore, a metal pipe other than a steel pipe may be used as the hollow material Pm. That is, the hollow material Pm may be a metal pipe made of a metal other than steel such as titanium or stainless steel.

As illustrated in FIG. 1, the manufacturing apparatus 10 includes a support device 11, a heating device 12, a cooling device 50, and a shearing force applying device 14. Further, FIG. 1 illustrates a plan view. Since the hollow material Pm of the present embodiment is a square pipe, two surfaces parallel to a paper surface in FIG. 1 may be referred to as an upper surface and a lower surface (a side in front of the paper surface is an upper surface a and a side behind is a lower surface b), and two side surfaces connecting the upper surface a and the lower surface b may be referred to as a left side surface c and a right side surface d.

(1) Support Device 11

In the support device 11, the hollow material Pm is fed in a longitudinal direction thereof by a feeding device (not illustrated) as indicated by the arrow F in FIG. 1. Reference sign CL illustrated in FIG. 1 is a central axis of the hollow material Pm at a position of the support device 11. At the position of the support device 11, the central axis CL is a straight line because shearing and bending processing has not been applied yet. When the shearing and bending processing is applied on the hollow material Pm, the central axis CL is also bent. Therefore, in the following description, instead of the central axis CL, an extension line EX of the central axis CL is used as a reference when indicating a direction. Specifically, as illustrated in XYZ coordinate axes of FIG. 1, a feeding direction (a leftward direction as viewed in FIG. 1) of the hollow material Pm along the extension line EX is referred to as a +X direction. In the following description, the +X direction may be simply referred to as a feeding direction or a downstream direction, and a −X direction may be simply referred to as an upstream direction. Also, when viewed in the downstream direction along the extension line EX from the position of the support device 11, a leftward direction (downward direction on the paper surface as viewed in FIG. 1) is referred to as a +Y direction. Further, a vertically upward direction (a side in front of the paper surface of FIG. 1) perpendicular to both the X direction and the Y direction is referred to as a +Z direction. The XYZ coordinate axes are also denoted on drawings after FIG. 1 to indicate information on directions.

An example of the feeding device is a type using an electric servo cylinder, but the feeding device is not limited to a specific type, and a known type such as a type using a ball screw or a type using a timing belt or a chain can be adopted.

The hollow material Pm is fed by the feeding device in the +X direction (feeding direction toward a left side on the paper surface along the arrow F) at a predetermined feeding speed. The hollow material Pm is supported by the support device 11 at a first position A. That is, the support device 11 supports the hollow material Pm that has been fed in the +X direction by the feeding device at the first position A.

In the present embodiment, a block is used as the support device 11. The block has a through hole 11a through which the hollow material Pm can be inserted with a gap. Although not illustrated, the block may be configured such that it is divided into a plurality of part blocks to be connected to a hydraulic cylinder or an air cylinder to sandwich and support the hollow material Pm. Also, the support device 11 is not limited to a specific type, and a known support device of this type can be adopted. For example, as another configuration, one set or two or more sets of a pair of hole-shaped rolls disposed to face each other can be provided in parallel to be used.

The support device 11 is fixedly disposed on a mounting table (not illustrated). However, the present invention is not limited to this aspect, and the support device 11 may be supported by an end effector (not illustrated) of an industrial robot.

The hollow material Pm passes through the first position A at which the support device 11 is installed and then is further fed in the +X direction.

(2) Heating Device 12

The heating device 12 is disposed at a second position B downstream of the first position A in the feeding direction of the hollow material Pm. The heating device 12 heats an entire circumference of a cross section of the hollow material Pin fed from the support device 11 at a portion in the longitudinal direction. An induction heating device is used as the heating device 12. As the induction heating device, any known device may be used as long as it has, for example, a coil for induction-heating the hollow material Pm at a high frequency.

A heating coil 12a of the heating device 12 is disposed to be separated from an outer surface of the hollow material Pm by a predetermined distance and surround an entire circumference of a cross section of the hollow material Pm at a portion in the longitudinal direction. The hollow material Pm is partially and rapidly heated by the heating device 12.

An installation means (not illustrated) of the heating device 12 can adjust an inclination angle of the heating coil 12a at the second position B. That is, the installation means of the heating device 12 can incline the heating coil 12a at a set angle with respect to the feeding direction of the hollow material Pm. In the example of FIG. 1, the heating coil 12a is disposed to be inclined to intersect the +X direction of the hollow material Pm (the feeding direction of the hollow material Pm indicated by the arrow F) at an inclination angle α in a side view. When the inclination angle α is made to be 90° or less, the heating coil 12a can be disposed to be inclined.

As the installation means of the heating device 12, for example, a well-known conventional end effector of an industrial robot can be exemplified, but a known one can be adopted as long as the inclination angle α can be adjusted as specified. The adjustment of the inclination angle α by the installation means of the heating device 12 may be configured such that the installation means receives a control signal from a control device 15 provided in the manufacturing apparatus 10 and automatically controls the inclination angle α. In this case, it is conceivable as an example that a relationship between a position at which the shearing and bending processing is performed in the longitudinal direction of the hollow material Pm and the inclination angle α to be set at the position is stored in advance in the control device 15, and the inclination angle α of the heating coil 12a when a feeding amount of the hollow material Pm reaches a predetermined feeding amount is controlled to form a predetermined angle.

Although not illustrated, one or more preheating devices (for example, small high-frequency heating devices) capable of preheating the hollow material Pm are disposed at an upstream position of the heating device 12 in the feeding direction of the hollow material Pm, and the hollow material Pm can also be heated by using the preheating means in combination with the heating device 12. In this case, the hollow material Pm can be heated a plurality of times.

(3) Cooling Device 50

The cooling device 50 is disposed at a third position C downstream of the second position B in the feeding direction of the hollow material Pm. The cooling device 50 rapidly cools a portion of the hollow material Pm heated at the second position B. When the hollow material Pm is cooled by the cooling device 50, a region sh between a first portion heated by the heating device 12 and a second portion cooled by the cooling device 50 is in a state in which a temperature is high and flow stress thereof is significantly reduced. The cooling device 50 is disposed adjacent to and immediately after the heating coil 12a on a downstream side. If necessary, this cooling device 50 may be used as a primary cooling device, and another cooling device may be provided in combination as a secondary cooling device on a downstream side of the cooling device 50. As illustrated in FIG. 1, only the cooling device 50 may be provided as a matter of course.

The cooling device 50 can also perform effective cooling even when a hollow bent part having a bent portion with a large bending angle with an extremely small bending radius is obtained by subjecting bending processing or shearing and bending processing to the hollow material Pm. Specifically, according to the present embodiment, effective cooling can be performed without involving backflow of a refrigerant even under processing conditions with a small bending radius and a large bending angle so that cooling water injected from a cooling water discharge hole positioned on a furthest downstream side in the feeding direction of the hollow material Pm does not collide with an outer circumference of the hollow material Pm after deformation in a case of a conventional cooling mechanism.

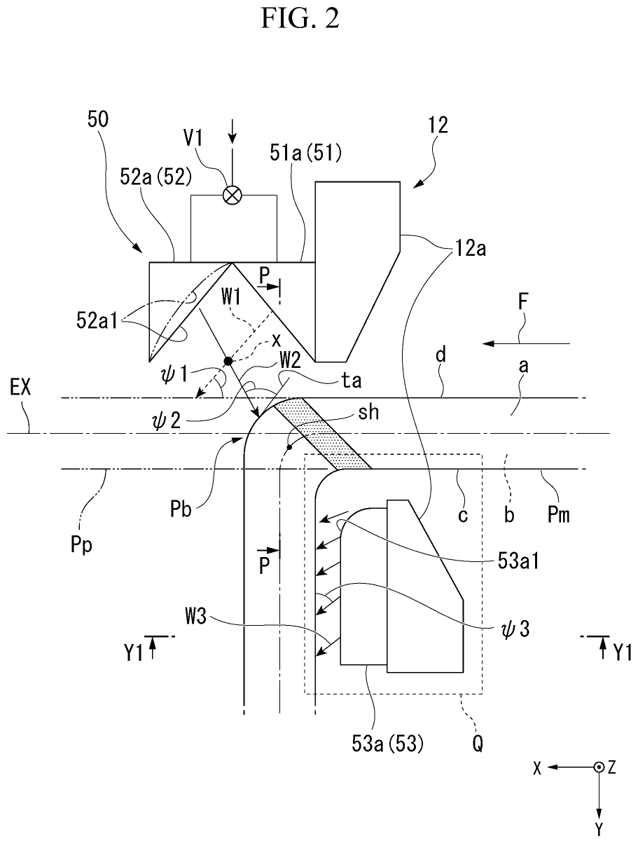

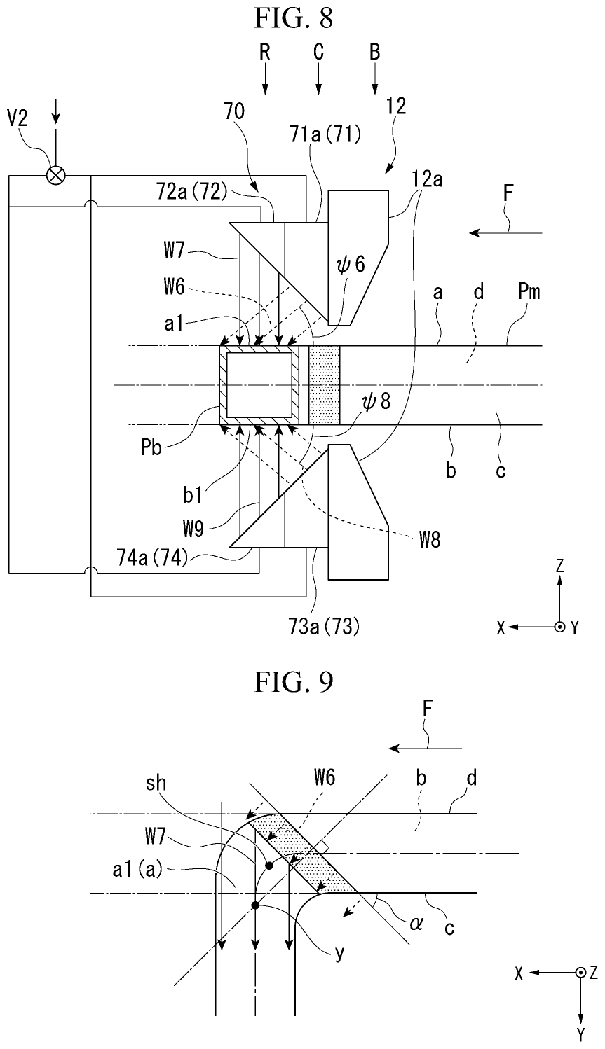

As illustrated in FIG. 2, the cooling device 50 of the present embodiment includes a first refrigerant injection device 51 (first cooling mechanism), a second refrigerant injection device 52 (first cooling mechanism), a valve V1 (first valve), a third refrigerant injection device 53 (second cooling mechanism), and an upper refrigerant injection device and a lower refrigerant injection device to be described later using FIG. 8 and subsequent drawings. In FIG. 2, for the sake of clarity of explanation, illustration of the upper refrigerant injection device and the lower refrigerant injection device is omitted.

When the hollow material Pm is viewed in a cross section perpendicular to the longitudinal direction thereof, the upper surface a is cooled by the upper refrigerant injection device, the lower surface b is cooled by the lower refrigerant injection device, the right side surface is cooled by the first refrigerant injection device 51 and the second refrigerant injection device 52, and the left side surface c is cooled by the third refrigerant injection device 53. Therefore, the four outer circumferential surfaces of the hollow material Pm are individually injected with the refrigerant and are uniformly cooled.

First, the first refrigerant injection device 51, the second refrigerant injection device 52, and the third refrigerant injection device 53 for cooling the left side surface c and the right side surface b of the hollow material Pm will be described.

The first refrigerant injection device 51 includes a nozzle 51a disposed adjacent to the heating coil 12a on a downstream side when viewed in the feeding direction of the hollow material Pm. The nozzle 51a is connected to the valve V1 via a pipe. When viewed in a plan view, an injection direction of the refrigerant injected from the nozzle 51a is a first direction (first injection direction) W1. The first direction W1 indicates a center line of the refrigerant injected from the nozzle 51a and is a direction forming an angle ϕ1 which is an acute angle with the X direction, in which the hollow material Pm is fed as it is without subjecting the shearing and bending processing to the hollow material Pm along the arrow F, as a reference (0 degrees) as illustrated in a virtual line of FIG. 2. That is, the injection direction of the refrigerant injected from the nozzle 51a is a positive direction (+X direction) in which a vector component parallel to the arrow F is directed in the feeding direction in the plan view illustrated in FIG. 2. Further, when the angle ϕ1 is set to 20 degrees or more and 70 degrees or less, the collision pressure of the refrigerant can be secured to obtain a sufficient cooling capacity, and the refrigerant can be prevented from flowing back in the feeding direction. Further, as the refrigerant, for example, cooling water can be used.

The second refrigerant injection device 52 includes a nozzle 52a disposed to be aligned with and adjacent to the nozzle 51a of the first refrigerant injection device 51 when viewed in the feeding direction of the hollow material Pm. That is, the heating coils 12a, the nozzles 51a, and the nozzles 52a are disposed in that order when viewed in the feeding direction.

The nozzle 52a is connected to the valve V1 via another pipe. When viewed in a plan view, an injection direction of the refrigerant injected from the nozzle 52a is a second direction (second injection direction) W2. The second direction W2 intersects the first direction W1 at an intersection x. In the plan view illustrated in FIG. 2, the intersection x is on a front side of the nozzles 51a and 52a on which distances from nozzle outlets of the nozzles 51a and 52a are smaller than a distance to a bent outer circumferential surface of a bent portion Pb.

The second direction W2 indicates a center line of the refrigerant injected from the nozzle 52a and is directed toward the right side surface d of the bent portion Pb formed by the shearing and bending processing as illustrated by the solid line in FIG. 2. That is, the injection direction of the refrigerant injected from the nozzle 52a is configured such that a vector component parallel to the arrow F is directed in a negative direction (−X direction) that is opposite to the feeding direction in the plan view illustrated in FIG. 2.

Further, an angle ϕ2 of the second direction W2 formed with a tangent line to at an intersection with the right side surface d is 20 degrees or more and 70 degrees or less. When the angle ϕ2 is set to 20 degrees or more, the collision pressure of the refrigerant can be secured, and a boiling bubble membrane formed due to a refrigerant on the outer surface of the hollow material Pm formed by membrane boiling can be broken. Thereby, a sufficient cooling capacity can be obtained by preventing the formation of the boiling bubble membrane on the outer surface of the hollow material Pm. The collision pressure of the refrigerant can be increased as the angle ϕ2 becomes larger, but if the angle ϕ2 is larger than 70 degrees, there is a likelihood that backflow of the refrigerant in the feeding direction will occur. Therefore, the backflow of the refrigerant is prevented by limiting the angle ϕ2 to 70 degrees or less.

The nozzle 52a has a nozzle surface 52a1 in which a plurality of nozzle outlets are formed. As illustrated by the two-dot dashed line in FIG. 2, the nozzle surface 52a1 may be a concave curved surface in accordance with a convex curved surface of the bent portion Pb. In this case, distances from nozzle outlets to the outer circumferential surface of the bent portion Pb can be made more uniform.

The valve V1 is connected to a pipe from the first refrigerant injection device 51 and a pipe from the second refrigerant injection device 52. The valve V1 is further connected to a main pipe from a refrigerant supply pump that supplies the refrigerant.

The valve V1 receives an instruction from the control device (first control unit) 15 and selectively switches a supply destination of the refrigerant fed from the refrigerant supply pump between one and the other of the nozzle 51a and the nozzle 52a. Thereby, when the refrigerant is injected from the nozzle 51a, the refrigerant injection from the nozzle 52a is stopped, and conversely, when the refrigerant is injected from the nozzle 52a, the refrigerant injection from the nozzle 51a is stopped.

More specifically, when the hollow material Pm is fed in the feeding direction as it is without performing the shearing and bending processing as illustrated in the virtual straight line of FIG. 2, an instruction is sent from the control device 15 to the valve V1, and the refrigerant is injected from the nozzle 51a with the refrigerant injection from the nozzle 52a stopped. On the other hand, when the shearing and bending processing has been performed on the hollow material Pm as illustrated by the solid line in FIG. 2, an instruction is sent from the control device 15 to the valve V1, and the refrigerant is injected from the nozzle 52a with the refrigerant injection from the nozzle 51a stopped. In both the cases, the refrigerant can hit the right side surface d at a spray angle with an appropriate inclination. As a result, even when the hollow bent part Pp having the bent portion Pb with an extremely small bending radius is obtained by shearing and bending processing, it is possible to secure the collision pressure of the refrigerant to obtain a sufficient cooling capacity and achieve uniform primary cooling in which non-uniformity of hardness of the product, particularly the right side surface d, is curbed.

As illustrated in FIG. 2, the third refrigerant injection device 53 includes a nozzle 53a disposed to be aligned with the heating coil 12a on a downstream side when viewed in the feeding direction of the hollow material Pm. The nozzle 53a is disposed at a position facing the nozzles 51a and 52a with the hollow material Pm interposed therebetween in a plan view.

The nozzle 53a is connected to the refrigerant supply pump via a pipe (not illustrated). The nozzle 53a has a nozzle surface 53a1 having a curvature in accordance with a curved surface shape of a bent inner circumferential surface (left side surface c) of the bent portion Pb. The nozzle surface 53a1 faces the inner circumferential surface (left side surface c) of the bent portion Pb and is disposed to have a distance with respect to the left side surface c of the hollow material Pm after the shearing and bending processing not to cause interference. A plurality of nozzle holes are formed on the nozzle surface 53a1 in the feeding direction of the hollow material Pm. The refrigerant is injected from the nozzle holes toward a third direction W3 to mainly cool the left side surface c. The third direction W3 indicates a center line of the refrigerant injected from each of the nozzle holes, and an angle ϕ3 thereof formed with the left side surface c is 20 degrees or more and 70 degrees or less. Thereby, the collision pressure required for breaking the boiling bubble membrane of the refrigerant can be secured to obtain a sufficient cooling capacity, and the refrigerant that has hit the left side surface c can be prevented from flowing back in the feeding direction.

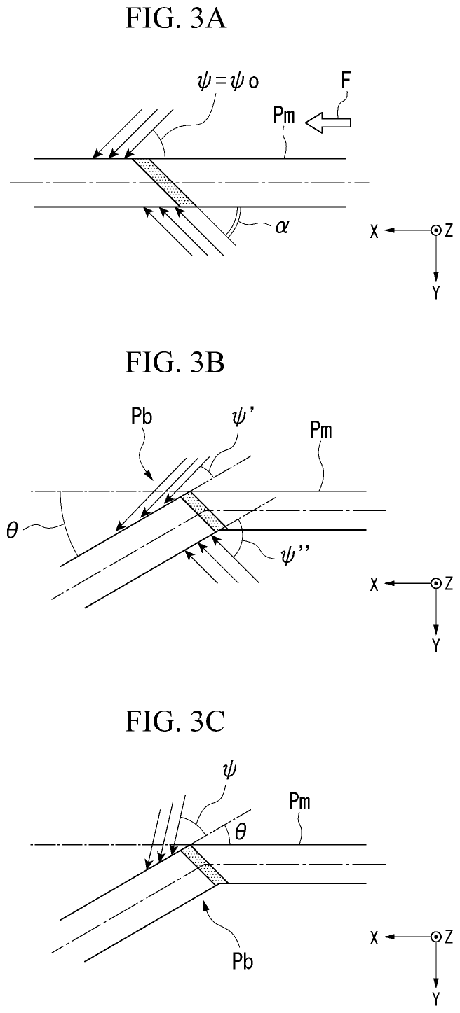

According to the first refrigerant injection device 51, the second refrigerant injection device 52, and the third refrigerant injection device 53 described above, both the left side surface c and the right side surface d of the bent portion Pb can be cooled uniformly. The reason will be described in detail with reference to FIGS. 3A to 5B. Here, cooling of the left side surface c and the right side surface d by the nozzles 51a, 52a, and 53a will be mainly described. In practice, in addition to the cooling by the nozzles 51a, 52a, and 53a, cooling by the upper refrigerant injection device and the lower refrigerant injection device is also performed at the same time. However, for the sake of clarity of explanation, description of the cooling by the upper refrigerant injection device and the lower refrigerant injection device will be described later.

FIGS. 3A and 3B illustrate a portion corresponding to the portion X of FIG. 1. Specifically, FIG. 3A is a view illustrating a conventional cooling method when the hollow material Pm is fed without shearing and bending processing, FIG. 3B is a view illustrating a conventional cooling method when the shearing and bending processing is performed on the hollow material Pm, and FIG. 3C is a view illustrating a case in which an injection direction of the refrigerant is changed when the shearing and bending processing is performed on the hollow material Pm.

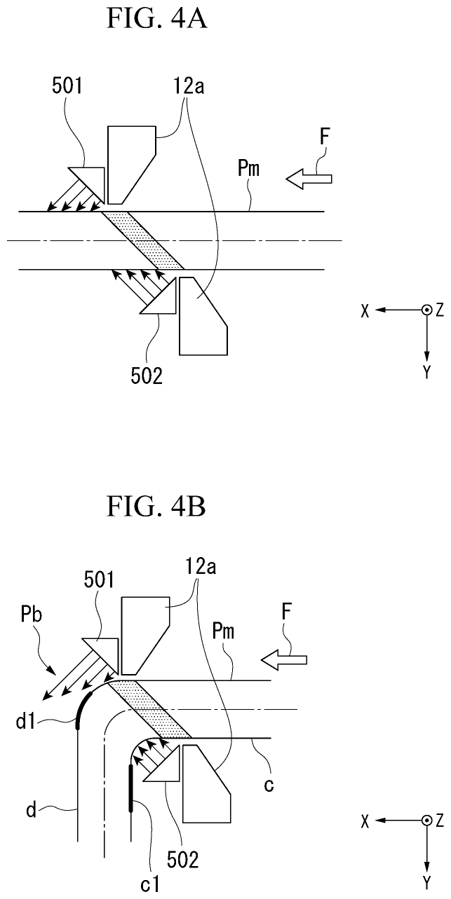

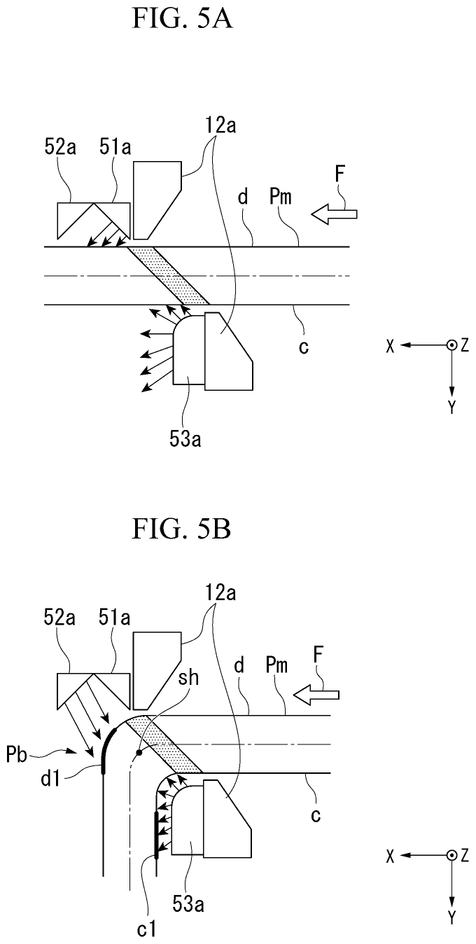

Also, FIGS. 4A and 4B each illustrate a portion corresponding to the portion X of FIG. 1. Specifically, FIG. 4A is a view illustrating a conventional cooling method when the hollow material Pm is fed without shearing and bending processing, and FIG. 4B is a view illustrating a conventional cooling method when the shearing and bending processing is performed on the hollow material Pm. Also, FIGS. 5A and 5B are views of the present embodiment illustrating the portion X of FIG. 1. Specifically, FIG. 5A is a view illustrating a cooling method when the hollow material Pm is fed without shearing and bending processing, and FIG. 5B is a view illustrating a cooling method when the shearing and bending processing is performed on the hollow material Pm.

A case in which the heating coil 12a is inclined to the inclination angle α as illustrated in FIG. 3A and the shearing and bending processing at a shear angle θ is performed as illustrated in FIG. 3B will be described.

In FIG. 3A, the hollow material Pm is locally heated by the heating coil 12a while being fed, and immediately thereafter, the refrigerant is injected from the cooling device 50 onto the hollow material Pm at an incident angle ϕ=ϕ₀ with respect to the feeding direction to cool the hollow material Pm. The refrigerant injected from the cooling device 50 collides with the hollow material Pm at the incident angle ϕ0 with respect to a traveling direction of the hollow material Pm.

For satisfactory cooling, it is necessary to secure the collision pressure of the refrigerant with respect to the hollow material Pm to break the boiling bubble membrane. That is, the closer to 90 degrees the incident angle ϕ is, the better. On the other hand, when the incident angle ϕ becomes too large, the refrigerant may flow back along a surface of the hollow material Pm. When the refrigerant flows back, in addition to not being able to obtain sufficient cooling capacity, since a boundary line between a heating region and a cooling region is not constant in a circumferential direction, not only a hardness distribution of the hollow bent part Pp becomes non-uniform, but also the bending processing by a shearing force becomes non-uniform. In order to perform satisfactory shearing and bending processing, it is necessary to prevent backflow of the refrigerant so that the boundary line between the heating region and the cooling region is constant in the circumferential direction.

The present inventors repeated numbers of experiments while changing a feed rate of the hollow material Pm and a configuration of the cooling device. As a result, it has been found that a satisfactory incident angle ϕ that does not generate backflow of the refrigerant while securing the collision pressure in the shearing and bending processing is within the range of the following expression 1.

20 degrees≤ϕ≤70 degrees (Expression 1)

Next, as illustrated in FIG. 3B, a case in which the shearing and bending processing is performed at the shear angle θ will be described. In this case, an incident angle ϕ′ of the refrigerant on an outer circumferential side of the bent portion Pb and an incident angle ϕ″ of the refrigerant on an inner circumferential side of the bent portion Pb have the following relationships of (expression 2) and (expression 3), respectively. As is apparent from expression 2, since the incident angle ϕ′ on the outer circumferential side of the bent portion Pb of the hollow material Pm decreases, there is a likelihood that the collision pressure will decrease and poor cooling will occur.

ϕ′=ϕ₀−θ (expression 2)

ϕ″=ϕ₀+θ (expression 3)

Particularly, this problem becomes prominent when the hollow bent part Pp with a sharp bent portion Pb in which a bending radius is extremely small, for example, 1 to 2 times or less than a diameter thereof (when the hollow material Pm has a rectangular cross section, a length of one side connecting a side edge of the bent inner circumferential surface and a side edge of the bent outer circumferential surface in a cross section perpendicular to a longitudinal direction thereof) is manufactured. That is, from expressions 1 and 2, for example, when ϕ₀=30 degrees, if the shear angle θ exceeds 10 degrees, there is a likelihood that the incident angle ϕ′ will be less than 20 degrees and the cooling capacity will decrease. When the shear angle θ further increases and exceeds 30 degrees, geometrically, there is a likelihood that the refrigerant will not directly hit the outer circumferential side of the bent portion Pb of the hollow material Pm and cooling will not be possible.

Therefore, as illustrated in FIG. 3C, when the incident angle ϕ is set to satisfy expression 1 for the outer circumferential side of the bent portion Pb of the hollow material Pm that is sharply bent, it is possible to achieve satisfactory cooling. For that purpose, a compact cooling device is required.

On the other hand, since the incident angle ϕ″ on the inner circumferential side of the bent portion Pb of the hollow material Pm increases as is apparent from expression 3, backflow is likely to occur. From expressions 1 and 3, when the shear angle θ exceeds 40 degrees, the incident angle ϕ″ exceeds 70 degrees, and there is a high likelihood that backflow will occur. Therefore, when the incident angle is set so that express 1 is satisfied on the inner circumferential side of the bent portion Pb of the hollow material Pm that is sharply bent, it is possible to achieve satisfactory cooling. For that purpose, a compact cooling device is required.

Next, a case in which the hollow bent part Pp with a rectangular cross section perpendicular to the longitudinal direction and bending at 90 degrees is manufactured using the shearing and bending processing described in Patent Document 2 will be described with reference to FIGS. 4A and 4B.

As illustrated in FIG. 4A, when the shearing and bending processing is not performed, the hollow material Pm moves in the arrow F direction while a distal end thereof remains gripped by the shearing force applying device 14. The hollow material Pm is rapidly heated by the heating coil 12a disposed at the inclination angle α with respect to the feeding direction and is cooled by receiving the refrigerant injected from refrigerant injection nozzles 501 and 502.

On the other hand, as illustrated in FIG. 4B, when the shearing and bending processing is performed, the refrigerant does not directly hit a portion dl of the outer circumferential surface (right side surface d) of the bent portion Pb. Therefore, a cooling capacity is insufficient at this portion, and this may cause a non-uniform strength to occur in the hollow bent part Pp. In addition, since the incident angle ϕ exceeds 70 degrees in a portion c1 of the inner circumferential surface (left side surface c) of the bent portion Pb, there is a likelihood that backflow of the refrigerant will occur.

In contrast to the conventional configurations described above, the cooling device of the present embodiment adopts the configuration illustrated in FIGS. 5A and 5B. Since the detailed configuration has already been described with reference to FIG. 2, duplicate description will be omitted here.

First, as illustrated in FIG. 5A, the hollow material Pm is locally heated by the heating coil 12a while being fed, and immediately thereafter, the refrigerant is injected from the nozzles 51a and 53a of the cooling device at the incident angle ϕ=ϕ₀ with respect to the feeding direction. The hollow material Pm is cooled by receiving the refrigerant. At this time, since the refrigerant injection from the nozzle 52a is stopped, the refrigerant injection from the nozzle 51a is not hindered.

The refrigerant injected from the nozzles 51a and 53a of the cooling device collides with the hollow material Pm at the incident angle ϕ₀ with respect to the traveling direction of the hollow material Pm. At this time, the incident angles ϕ of the refrigerant injected from the nozzles 51a and 53a all satisfy 20 degrees or more and 70 degrees or less. Therefore, it is possible to secure the collision pressure to obtain a sufficient cooling capacity and achieve uniform cooling without involving backflow of the refrigerant.

Also, as illustrated in FIG. 5B, when the shearing and bending processing is performed at a right angle, the refrigerant injection from the nozzle 53a of the present embodiment is continuously performed. On the other hand, the refrigerant injection from the nozzle 51a is stopped and the refrigerant injection from the nozzle 52a is started. At this time, since the refrigerant injection from the nozzle 51a is stopped, the refrigerant injection from the nozzle 52a is not hindered.

As a result, the portion dl that has not been able to be cooled by the conventional refrigerant injection nozzle 501 illustrated in FIG. 4B can be cooled by the refrigerant from the nozzle 52a illustrated in FIG. 5B. In addition, the portion c1 having a likelihood of backflow with the conventional refrigerant injection nozzle 502 illustrated in FIG. 4B can be cooled by the refrigerant from the nozzle 53a illustrated in FIG. 5B without involving backflow. Therefore, according to the present embodiment, it is possible to secure the collision pressure required for breaking the boiling bubble membrane to obtain a sufficient cooling capacity and achieve uniform cooling without involving backflow of the refrigerant.

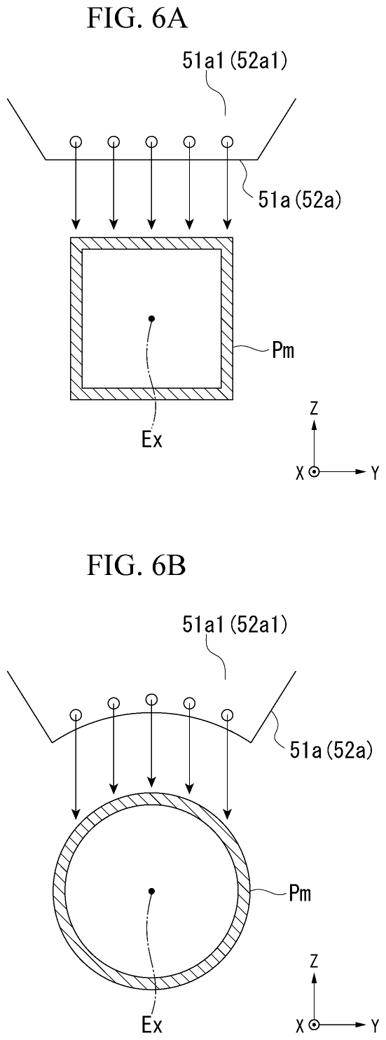

Further, as illustrated in FIG. 6A, when an outer shape of the hollow material Pm in a cross section perpendicular to the extension line EX is rectangular as in the present embodiment, the nozzle surfaces 51a1 and 52a1 on which the nozzle holes are formed to face the hollow material Pm may be flat surfaces in the nozzles 51a and 52a. Alternatively, when an outer shape of the hollow material Pm in the cross section perpendicular to the extension line EX is circular as illustrated in a modified example of FIG. 6B, the nozzle surfaces 51a1 and 52a1 may be concave curved surfaces. In both the cases of FIGS. 6A and 6B, distances from the nozzle holes to the outer surface (upper surface) of the hollow material Pm can be made equal to make water pressure on the outer surface more uniform.

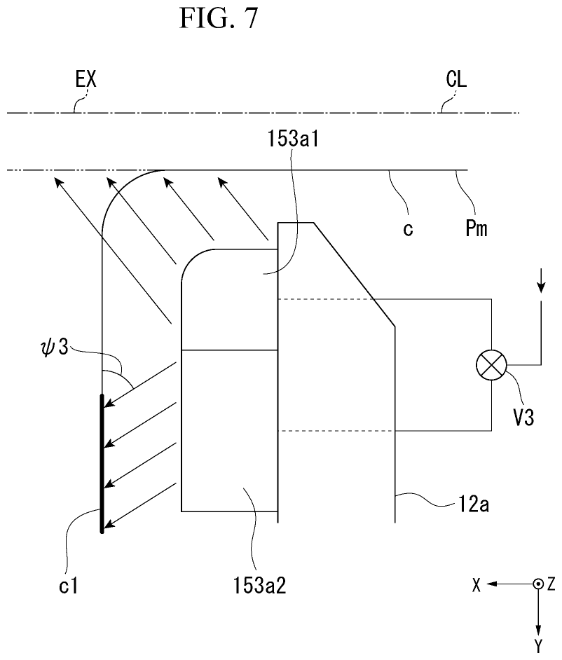

Also, in the present embodiment, a case in which the third refrigerant injection device 53 illustrated in FIG. 2 includes the nozzle 53a alone has been exemplified, but the present invention is not limited only to the configuration. For example, as illustrated in the modified example of FIG. 7, a combination of part nozzles 153a1 and 153a2 may be adopted instead of the nozzle 53a.

The part nozzle 153a1 (first part nozzle) is relatively closer to the extension line EX than the part nozzle 153a1, and an injection direction of the refrigerant injected from the nozzle holes forms an angle of 20 degrees or more and 70 degrees or less with respect to the extension line EX.

The part nozzle 153a2 (second part nozzles) is disposed to be aligned with the part nozzles 153a1, and an injection direction of the refrigerant injected from the nozzle holes forms the angle ϕ3 of 20 degrees or more and 70 degrees or less with respect to the left side surface c of the hollow material Pm after the bending processing.

The part nozzles 153a1 and 153a2 are each connected to a valve V3 via individual pipes. Similar to the valve V1, a main pipe for supplying the refrigerant is connected to the valve V3. A supply destination of the refrigerant supplied from the main pipe is switched between the part nozzles 153a1 and 153a2 by a switching operation of the valve V3.

Specifically, when the hollow material Pm is fed in a straight line in the downstream direction along the extension line EX without shearing and bending processing, the supply destination of the refrigerant is set to the part nozzle 153a1 by switching of the valve V3. In this case, the refrigerant is not injected from the part nozzle 153a2, and the refrigerant is injected from only the part nozzle 153a1 onto the left side surface c of the hollow material Pm.

On the other hand, when the shearing and bending processing is performed on the hollow material Pm, the supply destination of the refrigerant is set to the part nozzle 153a2 by switching of the valve V3. In this case, the refrigerant is not injected from the part nozzle 153a1, and the refrigerant is injected from only the part nozzle 153a2 onto the left side surface c of the hollow material Pm. Thereby, the portion c1 illustrated in FIG. 7 can be effectively cooled, and the refrigerant injected from the part nozzle 153a1 can be more effectively prevented from flowing back toward the upstream side.

When the injection angle of the refrigerant with respect to the hollow material Pm exceeds 30 degrees and is close to a right angle, a cooling efficiency thereof increases, but a likelihood of backflow also increases. When the hollow material Pm is bent at 90 degrees by shearing and bending processing as illustrated in FIG. 7, backflow is likely to occur at a portion of the bending whose inner circumferential surface is cooled. Particularly, in a portion at which the original linear shape starts to bend, the backflow occurs and the refrigerant is likely to be directed toward the heating coil 12a. In contrast, in the present modified example, since the injection of the refrigerant from the part nozzle 153a1 is stopped during the shearing and bending processing, the backflow does not occur. As described above, the valve V3 is provided to switch the supply destination of the refrigerant to prevent the backflow in the present modified example, but a role thereof is different from that of the valve V1 (see FIG. 1) that is switched so that the refrigerant reaches the injection destination.

Further, a switching timing of the valve V3 may be synchronized with a switching timing of the valve V1, or the switching timings may be different depending on bending conditions of the hollow material Pm. The valves V1 and V3 are both switched by the control device 15.

Next, the upper refrigerant injection device and the lower refrigerant injection device will be described.

In the present embodiment, the cooling device 50 includes a vertical cooling device 70 illustrated in FIG. 8. FIG. 8 is a view along line Y1-Y1 indicated by the arrows in FIG. 2, and for the sake of explanation, illustrations of the first refrigerant injection device 51 to the third refrigerant injection device 53 are omitted.

The vertical cooling device 70 includes upper refrigerant injection devices 71 and 72, lower refrigerant injection devices 73 and 74, and a valve V2 (second valve).

The upper refrigerant injection device (fifth refrigerant injection device) 71 includes a nozzle 71a disposed adjacent to the heating coil 12a on a downstream side when viewed in the feeding direction (direction along the arrow F) of the hollow material Pm. The nozzle 71a is connected to the valve V2 via a pipe. In a side view illustrated in FIG. 8, an injection direction of the refrigerant injected from the nozzle 71a is a sixth direction (third injection direction) W6. A bent surface a1 illustrated in FIG. 8 is a portion of the upper surface a to be the bent portion Pb.

The sixth direction W6 indicates a center line of the refrigerant injected from the nozzle 71a, and is a direction forming an angle ϕ6 which is an acute angle with a straight line when the center line is projected onto the upper surface a in a plan view as a reference (0 degrees). Here, when the angle ϕ6 is set to 20 degrees or more and 70 degrees or less, the refrigerant can be prevented from flowing back in the feeding direction. When viewed in a −Y direction illustrated in FIG. 8, the sixth direction W6 is inclined with respect to the bent surface a1. On the other hand, the sixth direction W6 is inclined with respect to the feeding direction when viewed in a direction facing the bent surface a1 as illustrated in FIG. 9.

The upper refrigerant injection device (sixth refrigerant injection device) 72 includes a nozzle 72a disposed to be aligned with and adjacent to the nozzle 71a when viewed in the feeding direction of the hollow material Pm. That is, the heating coil 12a, the nozzle 71a, and the nozzle 72a are aligned in that order when viewed in the feeding direction.

The nozzle 72a is connected to the valve V2 via another pipe. An injection direction of the refrigerant injected from the nozzle 72a is a seventh direction (fourth injection direction) W7. The seventh direction W7 indicates a center line of the refrigerant injected from the nozzle 72a and is directed toward the bent surface a1 as illustrated by the solid line in FIG. 8. Here, the seventh direction W7 is a direction forming an acute angle with a straight line when the center line is projected onto the upper surface a in a plan view as a reference (0 degrees). When the angle of the seventh direction is set to 20 degrees or more and 70 degrees or less, the collision pressure required for breaking the boiling bubble membrane can be secured to obtain a sufficient cooling capacity, and the refrigerant can be prevented from flowing back in the feeding direction. Then, in the view of FIG. 9 facing the bent surface a1, the sixth direction (third injection direction) W6 and the seventh direction (fourth injection direction) W7, which are the injection directions of the refrigerant, intersect at an intersection y.

The lower refrigerant injection devices 73 and 74 are disposed below the hollow material Pm as illustrated in FIG. 8. That is, the lower refrigerant injection devices 73 and 74 face the upper refrigerant injection devices 71 and 72 with the hollow material Pm sandwiched therebetween in a side view.

The lower refrigerant injection device (fifth refrigerant injection device) 73 includes a nozzle 73a disposed adjacent to the heating coil 12a on a downstream side when viewed in the feeding direction (direction along the arrow F) of the hollow material Pm. The nozzle 73a is connected to the valve V2 via a pipe. When viewed in the −Y direction as illustrated in FIG. 8, an injection direction of the refrigerant injected from the nozzle 73a is an eighth direction (third injection direction) W8. The eighth direction W8 indicates a center line of the refrigerant injected from the nozzle 73a, and is a direction forming an angle ϕ8 which is an acute angle with a straight line when the center line is projected onto the lower surface b in a bottom view as a reference (0 degrees). Here, when the angle ϕ8 is set to 20 degrees or more and 70 degrees or less, the collision pressure required for breaking the boiling bubble membrane can be secured to obtain a sufficient cooling capacity, and backflow can also be prevented. When viewed in the −Y direction as illustrated in FIG. 8, the eighth direction W8 is inclined with respect to the bent surface b1. Here, the bent surface b1 refers to a portion of the lower surface b to be the bent portion Pb.

On the other hand, the eighth direction W8 is inclined with respect to the feeding direction when viewed in a direction facing the bent surface b1.

The lower refrigerant injection device (sixth refrigerant injection device) 74 includes a nozzle 74a disposed to be aligned with and adjacent to the nozzle 73a when viewed in the feeding direction of the hollow material Pm. That is, the heating coil 12a, the nozzle 73a, and the nozzle 74a are disposed in that order when viewed in the feeding direction.

The nozzle 74a is connected to the valve V2 via another pipe. An injection direction of the refrigerant injected from the nozzle 74a is a ninth direction (fourth injection direction) W9. The ninth direction W9 indicates a center line of the refrigerant injected from the nozzle 74a and is directed toward the bent surface b1 as illustrated by the solid line in FIG. 8. Here, the ninth direction W9 is a direction forming an acute angle with a straight line when the center line is projected onto the lower surface b in a bottom view as a reference (0 degrees). When the angle of the ninth direction W9 is set to 20 degrees or more and 70 degrees or less, the refrigerant can be prevented from flowing back in the feeding direction. Then, when viewed in a direction facing the bent surface b1, the eighth direction (third injection direction) W8 and the ninth direction (fourth injection direction) W9, which are the injection directions of the refrigerant, intersect.

The valve V2 is connected to the pipes from the upper refrigerant injection devices 71 and 72 and the pipes from the lower refrigerant injection devices 73 and 74.

The valve V2 receives an instruction from a control device (second control unit) 15 and selectively switches a supply destination of the refrigerant fed from the refrigerant supply pump between one and the other of the nozzles 71a and 72a. At the same time, the valve V2 selectively switches a supply destination of the refrigerant fed from the refrigerant supply pump between one and the other of the nozzles 73a and 74a.

As a result, when the refrigerant is injected from the nozzles 71a and 73a, the refrigerant injection from the nozzles 72a and 74a is stopped, and conversely, when the refrigerant is injected from the nozzles 72a and 74a, the refrigerant injection from the nozzles 71a and 73a is stopped.

More specifically, when the hollow material Pm is fed in the feeding direction as it is without performing the shearing and bending processing as illustrated by the virtual line in FIGS. 8 and 9, an instruction is sent from the control device 15 to the valve V2, and the refrigerant is injected from the nozzles 71a and 73a with the refrigerant injection from the nozzles 72a and 74a stopped.

On the other hand, when the shearing and bending processing has been performed on the hollow material Pm as illustrated by the solid line in FIGS. 8 and 9, an instruction is sent from the control device 15 to the valve V2, and the refrigerant is injected from the nozzles 72a and 74a with the refrigerant injection from the nozzles 71a and 73a stopped.

According to the above-described configuration, in the plan view (or the bottom view from a back surface thereof) illustrated in FIG. 9, the injection direction of the refrigerant can be changed from the sixth direction W6 (the eighth direction W8) to the seventh direction W7 (the ninth direction W9) according to a bend of the bent portion Pb.

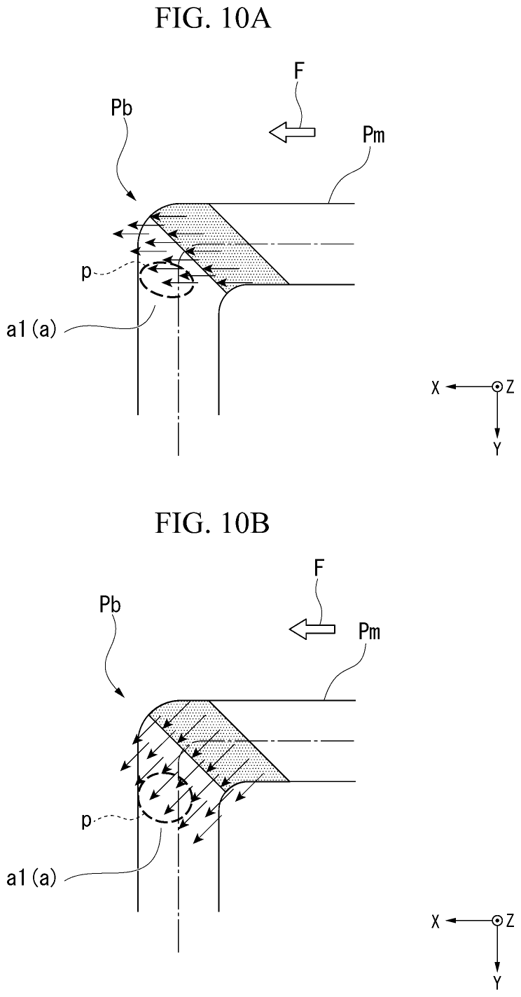

Thereby, the refrigerant can be injected to the back of bent ends of the bent surfaces a1 and b1. The reason will be described in detail with reference to FIGS. 10A and 10B.

FIG. 10A is a schematic view illustrating a conventional primary cooling method and illustrates a cooling state of the upper surface a when the hollow material Pm (steel pipe) with a rectangular cross section is subjected to quenching while the shearing and bending processing is performed so that the shear angle θ is 90 degrees. In the conventional primary cooling method, an injection direction of the refrigerant is parallel to the feeding direction indicated by the arrow F. Therefore, the refrigerant does not easily directly hit the bent end (portion p) of the bent surface a1 with a sharp bend. As a result, the cooling capacity for the portion p may be insufficient, and there is a likelihood that a product strength of the hollow bent part Pp will be non-uniform.

On the other hand, FIG. 10B is a schematic view illustrating a primary cooling method of the present embodiment and illustrates a cooling state of the upper surface a when the hollow material Pm (steel pipe) with a rectangular cross section is subjected to quenching while the shearing and bending processing is performed so that the shear angle θ is 90 degrees. In the primary cooling method of the present embodiment, an angle of the injection direction is set according to the shear angle θ, and directions of the seventh direction W7 and the ninth direction W9 are inclined so that the refrigerant directly hits the bent ends (portions p) of the bent surfaces a1 and b1. Thereby, the refrigerant is made to directly hit the bent ends (portions p) of the bent surfaces a1 and b1. Therefore, the cooling capacity for the portion p is sufficiently secured, and a product-predetermined uniform strength of the hollow bent part Pp can be obtained.

According to the cooling device 50 including the vertical cooling device 70 described above, in addition to the left side surface c and the right side surface d, the upper surface a and the lower surface b are also cooled at the third position C. Although it depends on types of steel of the hollow material Pm, a strength of the bent portion Pb can be increased by performing quenching on it with a cooling rate at the time of the cooling set to 100° C./sec or more.

When the hollow material Pm is fed straight without applying the shearing and bending processing, the refrigerant is injected onto the upper surface a from the nozzle 71a in the sixth direction W6. Similarly, the refrigerant is injected onto the lower surface b from the nozzle 73a in the eighth direction W8. At this time, the refrigerant injection from the nozzles 72a and 74a is stopped.

Next, when the shearing and bending processing is applied to the hollow material Pm, the control device 15 switches the valve V2. As a result, the refrigerant is injected onto the upper surface a from the nozzle 72a in the seventh direction W7. Similarly, the refrigerant is injected onto the lower surface b from the nozzle 74a in the ninth direction W9. At this time, the refrigerant injection from the nozzles 71a and 73a is stopped. Therefore, the refrigerant injection from the nozzles 72a and 74a can be performed without being hindered by the refrigerant from the nozzles 71a and 73a. Therefore, even when the shearing and bending processing in which the shear angle θ is close to a right angle is performed, the refrigerant can be injected to reach a back side of the bent end. Therefore, it is possible to achieve uniform and sufficient primary cooling.

In the present embodiment, the cooling device 50 includes the vertical cooling device 70 that cools a heated part including the bent surfaces a1 and b1 connecting the left side surface (bent inner circumferential surface) c and the right side surface (bent outer circumferential surface) d of the bent portion Pb with the refrigerant immediately after forming a predetermined shape including the bent portion Pb by moving a gripping position g in directions in two dimensions or directions in three dimensions while heating a portion of the hollow material Pm in the feeding direction while feeding the hollow material Pm in the feeding direction in a state in which one end portion of the long hollow material (steel) Pm is gripped at the gripping position g (see FIG. 1).

The vertical cooling device 70 includes the upper refrigerant injection device 71 and the lower refrigerant injection device 73 (the fifth refrigerant injection devices) in which injection directions (the sixth direction W6 and the eighth direction W8) of the refrigerant with respect to the bent surfaces a1 and b1 are inclined when viewed in the −Y direction illustrated in FIG. 8 and injection directions (the sixth direction W6 and the eighth direction W8) of the refrigerant are the third injection directions (the sixth direction W6 and the eighth directions W8) inclined with respect to the feeding direction when viewed in a direction facing the bent surfaces a1 and b1 illustrated in FIG. 9, the upper refrigerant injection device 72 and the lower refrigerant injection device 74 (the sixth refrigerant injection devices) disposed to be aligned with the upper refrigerant injection device 71 and the lower refrigerant injection device 73 on a downstream side in the feeding direction, and in which injection directions of the refrigerant with respect to the bent surfaces a1 and b1 are inclined when viewed in the −Y direction illustrated in FIG. 8 and injection directions of the refrigerant are the seventh direction W7 and the ninth direction W9 intersecting the sixth direction W6 and the eighth direction W8 when viewed in a direction facing the bent surfaces a1 and b1 illustrated in FIG. 9, the valve (the second valve) V2 that selectively switches a supply destination of the refrigerant between one and the other of the fifth refrigerant injection device and the sixth refrigerant injection device, and the control device (the second control unit) 15 that controls the valve V2.

According to the above-described configuration, when the valve V2 is controlled by the control device 15, the supply destination of the refrigerant can be switched between the upper refrigerant injection device 71 and the lower refrigerant injection device 73, and the upper refrigerant injection device 72 and the lower refrigerant injection device 74. Thereby, the refrigerant can be injected to reach a back side of the bent end on each of the bent surfaces a1 and b1. Therefore, it is possible to achieve uniform and sufficient primary cooling.

From another point of view, the primary cooling method of the present embodiment includes a process (third process) of injecting the refrigerant in the sixth direction W6 and the eighth direction W8 (third injection directions) inclined with respect to the bent surfaces a1 and b1 when viewed in the −Y direction illustrated in FIG. 8 and inclined with respect to the feeding direction when viewed in a direction facing the bent surfaces a1 and b1 illustrated in FIG. 9 at the first position in the feeding direction, and a process (fourth process) of injecting the refrigerant in the seventh direction W7 and the ninth direction W9 (fourth injection directions) inclined with respect to the bent surfaces a1 and b1 when viewed in the −Y direction illustrated in FIG. 8 and intersecting the third injection directions when viewed in a direction facing the bent surfaces a1 and b1 illustrated in FIG. 9 at the second position aligned with the first position in the feeding direction. Then, when the third process is performed, the fourth process is stopped, and when the fourth process is performed, the third process is stopped.

According to the primary cooling method, the supply destination of the refrigerant can be switched between the third process and the fourth process. Thereby, the refrigerant can be injected to reach a back side of the bent end on each of the bent surfaces a1 and b1. Therefore, it is possible to achieve uniform and sufficient primary cooling.

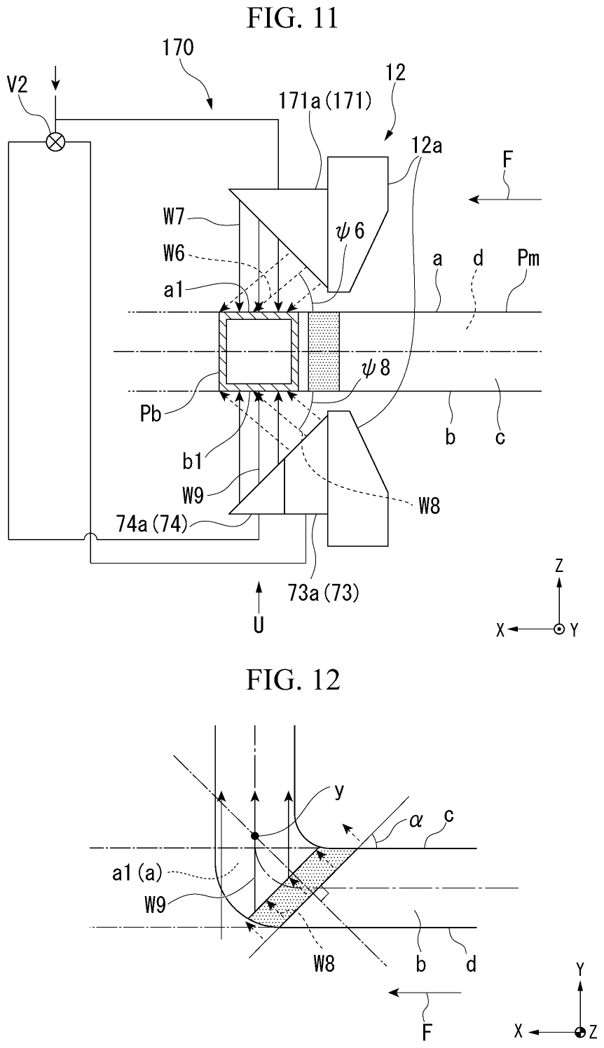

Instead of the configuration of the present embodiment illustrated in FIG. 8, a modified example illustrated in FIG. 11 can also be adopted. FIG. 11 is a view along line Y1-Y1 indicated by the arrows in FIG. 2 and is a view corresponding to FIG. 8.

In this modified example, a vertical cooling device 170 illustrated in FIG. 11 is provided in place of the vertical cooling device 70 illustrated in FIG. 8. The vertical cooling device 170 includes an upper refrigerant injection device 171, the lower refrigerant injection devices 73 and 74, and the valve (second valve) V2.

The upper refrigerant injection device 171 includes a nozzle 171a disposed adjacent to the heating coil 12a on a downstream side when viewed in the feeding direction (direction along the arrow F) of the hollow material Pm. The nozzle 171a is disposed immediately above the hollow material Pm. The nozzle 171a is directly connected to the main pipe without passing through the valve V2. The nozzle 171a is one in which the nozzle 71a and the nozzle 72a are integrally formed.

The nozzle 171a has the same nozzle holes as the nozzle holes of the nozzle 71a. Therefore, when viewed in the −Y direction illustrated in FIG. 11, an injection direction of the refrigerant injected from the nozzle 171a is the sixth direction (third injection direction) W6. Since details of the sixth direction W6 are as described above, duplicate description will be omitted here.

The nozzle 171a also has the same nozzle holes as the nozzle holes of the nozzle 72a in addition to the nozzle holes described above. An injection direction of the refrigerant injected from these nozzle holes is the seventh direction (fourth injection direction) W7. Since details of the seventh direction W7 are as described above, duplicate description will be omitted here.

However, in the present modified example, relative positions of the nozzle holes are adjusted so that the refrigerant injected in the sixth direction W6 and the refrigerant injected in the seventh direction W7 do not interfere with each other. Specifically, the refrigerant in the seventh direction W7 is injected through the refrigerant injected in the sixth direction W6.

As illustrated in FIG. 11, in the nozzle 171a, when viewed in the feeding direction (direction along the arrow F) of the hollow material Pm, the nozzle holes whose injection direction of the refrigerant is the seventh direction W7 are disposed to be aligned with the nozzle holes whose injection direction of the refrigerant is the sixth direction W6 on a downstream side. Both a flow path leading to the nozzle holes whose injection direction of the refrigerant is the sixth direction W6 and a flow path whose injection direction of the refrigerant is the seventh direction W7 are directly connected to the main pipe. That is, the pipe from the nozzle 171a is connected to the main pipe without passing through the valve V2. Therefore, the refrigerant supplied from the main pipe is simultaneously injected in the sixth direction W6 and the seventh direction W7 from all the nozzle holes of the nozzle 171a. Here, since the refrigerant injected in the sixth direction W6 and the refrigerant injected in the seventh direction W7 do not interfere with each other, the upper surface a of the hollow material Pm can be cooled even while a device configuration thereof is simple and inexpensive.

The nozzles 73a and 74a having the above-described configuration, position and direction are similarly disposed on a side opposite to the nozzle 171a disposed immediately above the hollow material Pm, that is, immediately below the hollow material Pm.

The nozzles 73a and 74a are each connected to the valve V2 via individual pipes. The valve V2 is connected to the main pipe. Therefore, a supply destination of the refrigerant supplied from the main pipe is switched to one or the other of the nozzles 73a and 74a by a switching operation of the valve V2.

Here, when the refrigerant is injected from one of the nozzles 73a and 74a by the switching operation of the valve V2, the injection of the refrigerant from the other thereof is stopped. Conversely, when the refrigerant is injected from the other of the nozzles 73a and 74a by the switching operation of the valve V2, the injection of the refrigerant from the one thereof is stopped.

More specifically, when the hollow material Pm is fed in the feeding direction as it is without performing the shearing and bending processing as illustrated in the virtual lines of FIGS. 11 and 12, an instruction is sent from the control device 15 to the valve V2, and the refrigerant is injected from the nozzle 73a in the third injection direction W8 with the refrigerant injection from the nozzle 74a stopped. On the other hand, when the shearing and bending processing has been performed on the hollow material Pm as illustrated by the solid line in FIGS. 11 and 12, an instruction is sent from the control device 15 to the valve V2, and the refrigerant is injected from the nozzle 74a in the fourth injection direction W9 with the refrigerant injection from the nozzle 73a stopped. Further, before and after the switching is performed by the valve V2, the refrigerant is sprayed from the nozzle 171a onto the upper surface a of the hollow material Pin in the two directions of the sixth direction W6 and the seventh direction W7.

Therefore, the refrigerant can be sprayed toward the lower surface b of the hollow material Pm from below without causing interference of the refrigerant between the nozzles 73a and 74a. Since the nozzles 73a and 74a spray the refrigerant upward toward the lower surface b of the hollow material Pm against gravity, a water pressure thereof tends to be slightly insufficient compared to the nozzle 171a that sprays the refrigerant downward. However, in the present configuration, since the supply destination of the refrigerant can be concentrated on either the nozzle 73a or 74a, decrease in water pressure does not occur. Therefore, it is possible to cool the lower surface b of the hollow material Pm with the cooling capacity not inferior to that of the upper surface a.

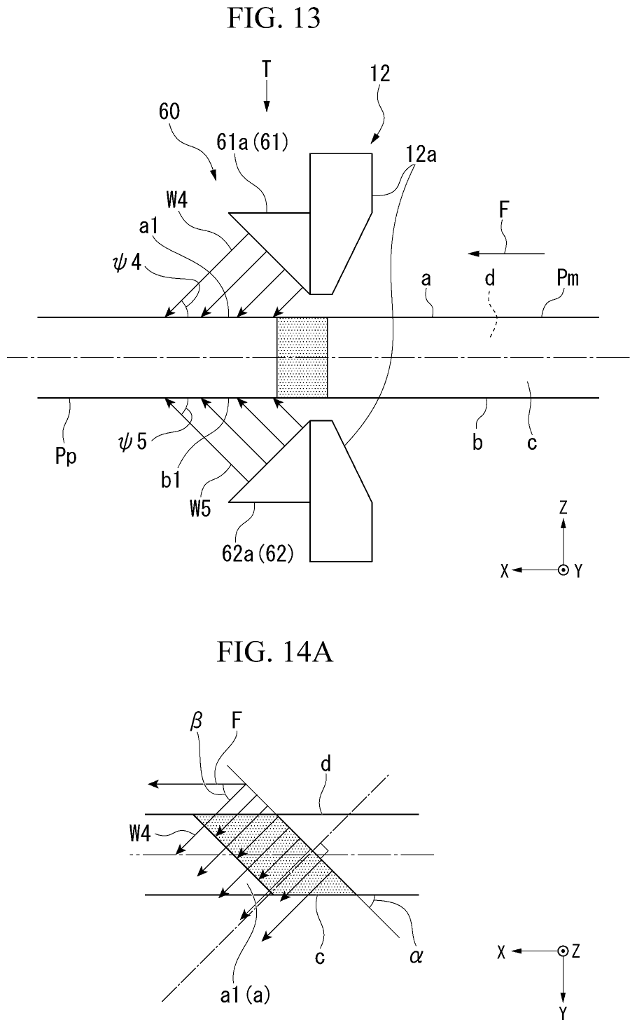

As still another modified example, the configuration illustrated in FIG. 13 can be adopted instead of the configuration illustrated in FIG. 8 of the present embodiment. FIG. 13 is a view along line Y1-Y1 indicated by the arrows in FIG. 2 and is a view from the same direction as that of FIG. 8.

In this modified example, a vertical cooling device 60 illustrated in FIG. 13 is provided in place of the vertical cooling device 70 illustrated in FIG. 8. Further, FIG. 13 is a side view of a portion corresponding to the portion X of FIG. 1, and for the sake of explanation, illustrations of the first refrigerant injection device 51 to the third refrigerant injection device 53 are omitted.

The vertical cooling device 60 includes a fourth refrigerant injection device 61 (upper refrigerant injection device) and a fifth refrigerant injection device 62 (lower refrigerant injection device).

The fourth refrigerant injection device 61 includes a nozzle 61a disposed adjacent to the heating coil 12a on a downstream side when viewed in the feeding direction of the hollow material Pin. The nozzle 61a is connected to the refrigerant supply pump via a pipe (not illustrated). As illustrated in FIG. 13, an injection direction of the refrigerant injected from the nozzle 61a is the fourth direction W4 when viewed in the −Y direction. The fourth direction W4 indicates a center line of the refrigerant injected from the nozzle 61a and is a direction forming an angle ϕ4 which is an acute angle with a straight line when the center line is projected onto the upper surface a in a plan view as a reference (0 degrees). Here, when the angle ϕ4 is set to 20 degrees or more and 70 degrees or less, the collision pressure required for breaking the boiling bubble membrane can be secured to obtain a sufficient cooling capacity, and the refrigerant can be prevented from flowing back in the feeding direction. As described above, when the fourth refrigerant injection device 61 is viewed in the −Y direction, the injection direction of the refrigerant with respect to the bent surface a1 when the shearing and bending processing has been performed is inclined.

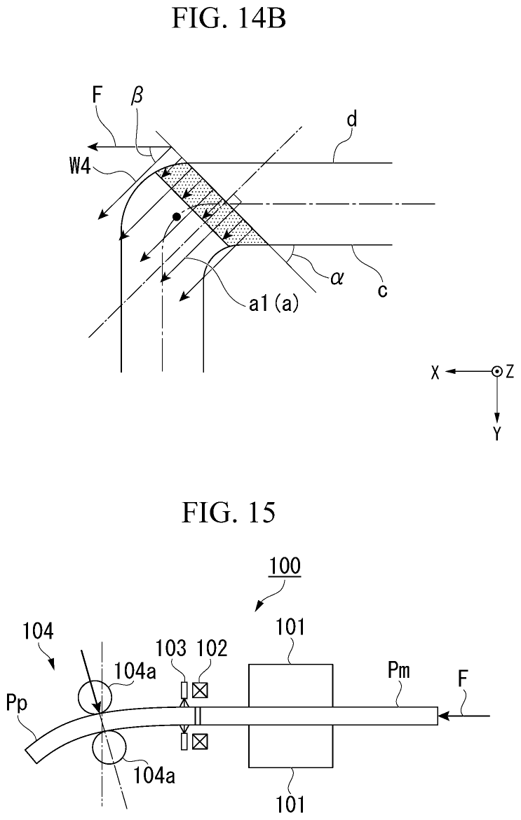

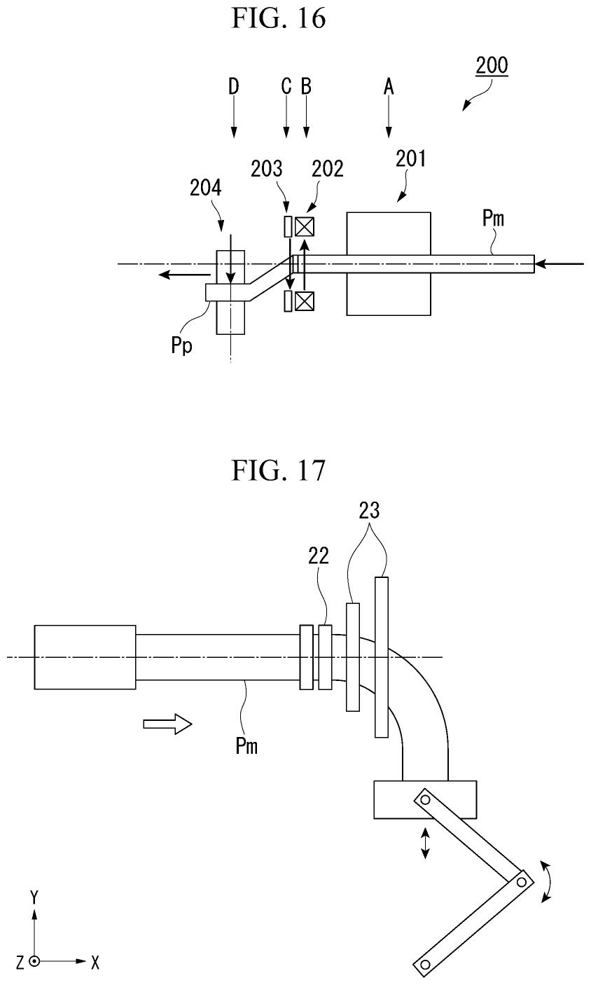

FIGS. 14A and 14B are views when FIG. 13 is seen from above. FIG. 14A illustrates a cooling state when the hollow material Pm is fed without shearing and bending processing. FIG. 14B illustrates a cooling state when the shearing and bending processing has been performed on the hollow material Pm.

When viewed in a direction facing the bent surfaces a1 as illustrated in FIG. 14B, an angle β of the fourth direction W4 of the refrigerant injected from the nozzle 61a formed with the feeding direction (direction along the arrow F) as a reference (0 degree) is approximately ½ of the shear angle θ. That is, when the shearing and bending processing in which the shear angle θ is 90 degrees (right angle) is performed, the angle β is 45 degrees, which is ½ of 90 degrees. However, the angle β does not need to be exactly ½ of 90 degrees, and may be deviated as long as it is within a range of +20 degrees to −20 degrees. That is, a lower limit of the angle β is (½)×θ (degrees)−20 (degrees), and an upper limit thereof is (½)×θ (degrees)+20 (degrees). For example, if the shear angle θ is 90 degrees, the lower limit of the angle β is 25 degrees and the upper limit thereof is 65 degrees (β=25 degrees to 65 degrees).

Such an angle β may be formed by a support mechanism (not illustrated) that holds the nozzle 61a so that the angle can be adjusted. In this case, the control device 15 changes the shear angle θ and at the same time sends an instruction to the support mechanism so that the angle β of the nozzle 61a is within the above-described range. The support mechanism that has received the instruction changes a direction of the nozzle 61a so that the angle β is within the above-described range.

Alternatively, the nozzle 61a may be integrally fixed to the heating coil 12a. In this case, the angle β is automatically changed in accordance with a change in the inclination angle α of the heating coil 12a.

The fifth refrigerant injection device 62 has the same configuration as the fourth refrigerant injection device 61. As illustrated in FIG. 13, the fifth refrigerant injection device 62 is disposed at a position facing the fourth refrigerant injection device 61 with the hollow material Pm sandwiched therebetween. That is, the fourth refrigerant injection device 61 is disposed above the hollow material Pm, and the fifth refrigerant injection device 62 is disposed below the hollow material Pm.

The fifth refrigerant injection device 62 includes a nozzle 62a disposed adjacent to the heating coil 12a on the downstream side when viewed in the feeding direction of the hollow material Pm. The nozzle 62a is connected to the refrigerant supply pump via a pipe (not illustrated). When viewed in the feeding direction, the injection direction of the refrigerant injected from the nozzle 62a is the fifth direction W5. The fifth direction W5 indicates a center line of the refrigerant injected from the nozzle 62a and is a direction forming an angle ϕ5 which is an acute angle with a straight line when the center line is projected onto the lower surface b in a bottom view as a reference (0 degrees). Here, when the angle ϕ5 is set to 20 degrees or more and 70 degrees or less, the collision pressure required for breaking the boiling bubble membrane can be secured to obtain a sufficient cooling capacity, and the refrigerant can be prevented from flowing back in the feeding direction. As described above, in a side view of the fifth refrigerant injection device 62 in the −Y direction, the injection direction of the refrigerant with respect to the bent surface b1 when the shearing and bending processing has been performed is inclined.

The fifth direction W5 when the nozzle 62a is viewed from below coincides with the fourth direction W4. When viewed in a direction facing the bent surfaces b1, the angle β of the fifth direction W5 of the refrigerant injected from the nozzle 62a formed with the feeding direction (direction along the arrow F) as a reference (0 degree) is approximately ½ of the shear angle θ. The angle β does not need to be exactly ½ of the shear angle θ, and may be deviated as long as it is within a range of +20 degrees to −20 degrees. That is, a lower limit of the angle β is (½)×θ(degrees)−20 (degrees), and an upper limit thereof is (½)×θ (degrees)+20 (degrees).

Further, since a method of adjusting the angle β is the same as that of the fourth refrigerant injection device 61, description thereof is omitted here.

According to the fourth refrigerant injection device 61 and the fifth refrigerant injection device 62 described above, as illustrated in FIG. 14B, even when the shearing and bending processing is performed at the shear angle θ close to a right angle, the bent surface a1 and b1 can be cooled uniformly. The reason is as described in detail above with reference to FIGS. 10A and 10B.

Next, a cooling method when the device configuration according to the present modified example is used will be described below.

The refrigerant is injected toward the hollow material Pm from the nozzles 61a and 62a of the vertical cooling device 60 disposed at the third position C downstream of the second position B in the feeding direction of the hollow material Pm. Thereby, the heated part is cooled at the third position C. Although it depends on types of steel of the hollow material Pm, a strength of the bent portion Pb can be increased by performing quenching on it with a cooling rate at the time of the cooling set to 100° C./sec or more.

Here, as illustrated in FIG. 14A, when the hollow material Pm is fed straight without applying the shearing and bending processing, the refrigerant is injected onto the upper surface a in the fourth direction W4 which forms the angle β with respect to the feeding direction in a plan view. Similarly, the refrigerant is injected onto the lower surface b in the fifth direction W5 forming the angle β.

In addition, the refrigerant injection is also performed onto the left side surface c and the right side surface d, but the specific method thereof has already been described in the above-described embodiment, and thus description thereof will be omitted here.

Next, as illustrated in FIG. 14B, even when the shearing and bending processing is applied to the hollow material Pm, the refrigerant is injected onto the upper surface a in the fourth direction W4 which forms the angle β with respect to the feeding direction in a plan view. Similarly, the refrigerant is injected onto the lower surface b in the fifth direction W5 forming the angle β. At this time, the angle β is adjusted in accordance with the shear angle θ. The refrigerant can be injected to reach a back side of the bent end on each of the bent surfaces a1 and b1 by adjusting the angle β. Therefore, it is possible to achieve uniform and sufficient primary cooling.

In addition, the refrigerant injection is also performed onto the left side surface c and the right side surface d, but the specific method thereof has already been described in the above-described first embodiment, and thus description thereof is omitted here.

The outline of the present modified example will be described below.

In the present modified example, the cooling device 50 includes the vertical cooling device 60 that cools a heated part including the bent surface a1 connecting the left side surface c (bent inner circumferential surface) and the right side surface d (bent outer circumferential surface) of the bent portion Pb with the refrigerant immediately after forming a predetermined shape including the bent portion Pb with the shear angle θ by moving the gripping position g in directions in two dimensions or directions in three dimensions while heating a portion of the hollow material Pm in the feeding direction while feeding the hollow material Pm in the feeding direction in a state in which one end portion of the long hollow material Pm (steel) is gripped at the gripping position g.

The vertical cooling device 60 includes the fourth refrigerant injection device 61 in which the fourth direction W4 of the refrigerant with respect to the bent surface a1 is inclined when viewed in the −Y direction in FIG. 13, and an angle formed by the fourth direction W4 of the refrigerant with respect to the feeding direction is approximately ½ of the shear angle θ when viewed in a direction facing the bent surface a1 in FIG. 14B.

Further, the vertical cooling device 60 includes the fifth refrigerant injection device 62 in which the fifth direction W5 of the refrigerant with respect to the bent surface b1 is inclined when viewed in the −Y direction in FIG. 13, and an angle formed by the fifth direction W5 of the refrigerant with respect to the feeding direction is approximately ½ of the shear angle θ when viewed in a direction facing the bent surface b1.

From another point of view, the present embodiment adopts the primary cooling method including a process of injecting the refrigerant in the fourth direction W4 that is inclined with respect to the bent surface a1 when viewed in the −Y direction of FIG. 13 and whose angle with respect to the feeding direction is approximately ½ of the shear angle θ when viewed in a direction facing the bent surface a1.

In addition, the primary cooling method also includes a process of injecting the refrigerant in the fifth direction W5 that is inclined with respect to the bent surface b1 when viewed in the −Y direction of FIG. 13 and whose angle with respect to the feeding direction is approximately ½ of the shear angle θ when viewed in a direction facing the bent surface b1.

According to the above-described vertical cooling device 60 and the primary cooling method, since an injection direction of the refrigerant with respect to the feeding direction is approximately ½ of the shear angle θ, the refrigerant can be injected to reach a back side of the bent end on each of the bent surfaces a1 and b1. Therefore, it is possible to achieve uniform and sufficient primary cooling.

Here, the description returns to the present embodiment illustrated in FIG. 1.

An installation means of the cooling device 50 may be any means as long as the cooling device 50 can be disposed at the third position C and is not limited to a specific installation means. However, in order to manufacture the hollow bent part Pp with high dimensional accuracy by the manufacturing apparatus 10 of the present embodiment, it is desirable to set the region sh between the first portion heated by the heating device 12 and the second portion cooled by the cooling device 50 as small as possible by setting a distance between the second position B and the third position C as small as possible. For this purpose, it is desirable to dispose the cooling device 50 close to the heating coil 12a. Therefore, as illustrated in FIG. 2, it is desirable to dispose the nozzles 51a, 52a, and 53a at a position immediately after the heating coil 12a. Further, the cooling device 50 may be fixed to the installation means of the heating device 12. In this case, both the nozzles 51a, 52a, and 53a and the heating coil 12a can be inclined at the same inclination angle α while maintaining a relative positional relationship between the nozzles 51a, 52a, and 53a and the heating coil 12a.

However, the present invention is not limited only to this configuration, and the installation means of the cooling device 50 may be provided separately from the installation means of the heating device 12. As the installation means of the cooling device 50 in this case, a known one such as, for example, a well-known and commonly used end effector of an industrial robot can be adopted.

(4) Shearing Force Applying Device 14

The shearing force applying device (bending force applying part) 14 is disposed at a fourth position D downstream of the third position C in the feeding direction of the hollow material Pm. The shearing force applying device 14 has an arm (not illustrated) that grips the hollow material Pm at the gripping position g, and the gripping position g is moved in directions in two dimensions or directions in three dimensions by an operation of the arm. For example, the gripping position g moves in directions in two dimensions without involving movement in the feeding direction by moving along a plane perpendicular to the feeding direction. Also, the gripping position g moves in directions in three dimensions accompanied by movement in the feeding direction by moving in an arbitrary direction in a three-dimensional space. Thereby, the shearing force applying device 14 performs the shearing and bending processing on the hollow material Pm by applying a shearing force to the region sh between the first portion heated by the heating device 12 and the second portion cooled by the cooling device 50 in the hollow material Pm.

The shearing force applying device 14 includes a pair of gripping means 14a and 14b connected to a distal end of the arm. The gripping means 14a and 14b come into contact with an outer surface or an inner surface of the hollow material Pm to move a position of the hollow material Pm while determining a support position thereof. Then, the shear angle θ illustrated in FIG. 1 can be adjusted by adjusting the support position. This shear angle θ is an angle between the feeding direction of the hollow material Pm and the outer surface of the hollow material Pm after passing through the cooling device 50.

Further, the means for gripping the hollow material Pm is not limited only to the pair of gripping means 14a and 14b described above, and other configurations may be adopted instead. For example, an inner surface chuck in which a plurality of claws connected to the distal end of the arm are provided and the hollow material Pm is held from the inside by opening the claws after inserting them into an opening distal end of the hollow material Pm may be adopted. Alternatively, an outer surface chuck in which an annular body similarly connected to the distal end of the arm is provided and the hollow material Pm is passed through the annular body so that an outer circumferential surface thereof is constrained by the annular body over the entire circumference may be adopted.

A cross section of the hollow material Pin at a part in the longitudinal direction is heated by the heating device 12, and flow stress thereof is significantly reduced. Therefore, when the gripping position g due to the pair of gripping means 14a and 14b is moved in directions in three dimensions at the fourth position D downstream of the third position C in the feeding direction of the hollow material Pm, as illustrated in FIG. 1, a shearing force Ws can be applied to the region sh between the first portion heated by the heating device 12 and the second portion cooled by the cooling device 50 in the hollow material Pm.

When the shearing force Ws acts on the hollow material Pin, the bent portion is formed. In the present embodiment, a shearing force is applied instead of applying a bending moment to the heated part of the hollow material Pm as in the invention disclosed in Patent Document 1. Therefore, it is possible to manufacture the hollow bent part Pp having a bent portion with an extremely small bending radius of 1 to 2 times or less than a width W (product width) which is a distance between an outer curve on an inner circumferential side and an outer curve on an outer circumferential side of the bent portion.

In the manufacturing method using the manufacturing apparatus 10 of the present embodiment, a processible range of the bending radius can be expanded by appropriately setting a combination of the shear angle θ and the inclination angle α. Therefore, a large bending radius in which the bending radius exceeds twice the width W can also be processed. On the other hand, even when a small bending radius is required for product design reasons, it is also possible to obtain an extremely small bending radius of 1 to 2 times or less than a diameter (when the metal pipe has a rectangular cross section, a length of one side connecting a side edge of the bent inner circumferential surface and a side edge of the bent outer circumferential surface in a cross section perpendicular to a longitudinal direction thereof) of the metal pipe which has been difficult with conventional technologies.

The shearing force applying device 14 may be installed via a mechanism capable of disposing the pair of gripping means 14a and 14b to be movable in directions in two dimensions or directions in three dimensions similarly to the arm described above. Such a mechanism does not require a particular limitation. For example, the gripping means 14a and 14b may be held by a well-known end effector of an industrial robot. For example, a mobile device that combines a linear guide and a servomotor (not illustrated) may be utilized.

### [Manufacturing Method of Hollow Bent Part]

Next, a method of manufacturing the hollow bent part Pp from the hollow material Pm using the manufacturing apparatus 10 of the present embodiment described above will be described below.

That is, in FIG. 1, first, the long hollow material Pm made of steel is supported by the support device 11 disposed at the first position A while being relatively fed in a longitudinal direction thereof by the feeding device.

Next, the fed hollow material Pm is partially and rapidly heated by the heating device 12.

When steel is used as the material, it is desirable that a heating temperature of the hollow material Pm be Ac3 point or higher of the steel constituting the hollow material Pm. When the heating temperature is set to Ac3 point or higher, the bent portion Pb of the hollow material Pm can be quenched by appropriately setting a cooling rate at the time of cooling that is performed following the heating. Moreover, the flow stress of the region sh between the first portion and the second portion of the hollow material Pm can be sufficiently reduced to such an extent that processing to have a desired small bending radius can be performed.

The refrigerant is injected toward the hollow material Pm from the nozzles 51a, 52a, and 53a of the cooling device 50 disposed at the third position C downstream from the second position B in the feeding direction of the hollow material Pm. Thereby, the heated part is cooled at the third position C. Although it depends on types of steel of the hollow material Pm, a strength of the bent portion Pb can be increased by performing quenching on it with a cooling rate at the time of the cooling set to 100° C./sec or more.

Further, as described above, when the hollow material Pm is fed straight without applying the shearing and bending processing, the refrigerant from the nozzle 51a is sprayed toward the right side surface d of the hollow material Pm after the refrigerant of the nozzle 52a is stopped. On the other hand, when the shearing and bending processing is applied to the hollow material Pm to form the bent portion Pb, the refrigerant from the nozzle 52a is sprayed toward the right side surface d which is the outer circumferential surface of the bent portion Pb after the refrigerant of the nozzle 51a is stopped.

Due to this cooling, the first portion heated by the heating device 12 and the second portion cooled by the cooling device 50 are formed in the hollow material Pm. The region sh between the first portion and the second portion of the hollow material Pm is at a high temperature state and the flow stress is significantly reduced.

When a distal end portion of a planned shearing and bending processing portion of the hollow material Pm reaches the pair of gripping means 14a and 14b of the shearing force applying device 14, the pair of gripping means 14a and 14b are moved in a direction (a downward direction on the paper surface as viewed in FIG. 1) in which two directions of the feeding direction of the hollow material Pm and a direction substantially parallel to a cross section in the longitudinal direction of the hollow material Pm heated by the heating device 12 are combined with an original position of the gripping means 14a and 14b as a starting point. At this time, the shear angle by the shearing force applying device 14 is set to θ.

In this way, the shearing force Ws is applied to the region sh between the first portion and the second portion of the hollow material Pm, the shearing and bending processing is performed on the hollow material Pm, and the hollow bent part Pp can be obtained.

The outline of the present embodiment will be described below.

The present embodiment adopts the cooling device 50 that cools the heated part including the bent outer circumferential surface of the bent portion Pb with the refrigerant immediately after forming a predetermined shape including the bent portion Pb by moving one end portion of the long steel (hollow material Pm) in directions in two dimensions or directions in three dimensions while heating a portion of the hollow material Pm in the feeding direction while feeding the hollow material Pm in the feeding direction in a state in which the one end portion is gripped. Then, the cooling device 50 includes the first refrigerant injection device 51 in which an injection direction of the refrigerant as viewed from a direction perpendicular to the feeding direction is the first direction W1, the second refrigerant injection device 52 disposed to be aligned with the first refrigerant injection device 51 in the feeding direction and whose injection direction of the refrigerant as viewed from the perpendicular direction is the second direction W2 that intersects the first direction W1, the valve (first valve) that selectively switches a supply destination of the refrigerant between one and the other of the first refrigerant injection device 51 and the second refrigerant injection device 52, and the control device 15 that controls the valve.

According to the above-described configuration, the supply destination of the refrigerant can be switched between the first refrigerant injection device 51 and the second refrigerant injection device 52 by controlling the valve by the control device 15. Thereby, the outer circumferential surface of the bent portion Pb can be cooled from an appropriate direction, and uniform and sufficient primary cooling is possible.

Further, the present embodiment includes the third refrigerant injection device 53 in which an angle formed by the injection direction of the refrigerant with respect to the bent inner circumferential surface of the hollow material Pm when viewed in the feeding direction is 20 degrees or more and 70 degrees or less.

According to this configuration, since the injection direction of the refrigerant forms an angle of 20 degrees or more and 70 degrees or less with respect to the bent inner circumferential surface, the collision pressure is secured to obtain a sufficient cooling capacity, and the refrigerant can be effectively prevented from flowing back in the feeding direction. Therefore, it is possible to achieve uniform primary cooling.

From another viewpoint, the present embodiment adopts the primary cooling method in which the heated part including the bent outer circumferential surface of the bent portion Pb is cooled with the refrigerant immediately after forming a predetermined shape including the bent portion Pb by moving one end portion of the long steel (hollow material Pm) in directions in two dimensions or three dimensions direction while heating a portion of the hollow material Pm in the feeding direction while feeding the hollow material Pm in the feeding direction in a state in which the one end portion is gripped.

Then, the primary cooling method includes a first process of injecting the refrigerant in the first direction W1 at the first position on a downstream side of the heating coil 12a when viewed in the feeding direction, and a second process of injecting the refrigerant in the second direction W2 intersecting the first direction W1 at the second position that is aligned with the first position on a further downstream side when viewed in the feeding direction. When the shearing and bending processing is not performed, the first process is performed and the second process is stopped. On the other hand, when the shearing and bending processing is performed, the second process is performed and the first process is stopped.

According to the above-described method, the supply destination of the refrigerant can be switched between the first process and the second process in accordance with presence or absence of the shearing and bending processing. Thereby, since the outer circumferential surface (right side surface d) of the bent portion Pb can be cooled from an appropriate direction, it is possible to achieve uniform and sufficient primary cooling.

Further, the present embodiment includes a process of injecting the refrigerant in an injection direction of 20 degrees or more and 70 degrees or less with respect to the bent inner circumferential surface (left side surface c) of the hollow material Pm when viewed in the feeding direction.

According to the above-described method, the refrigerant can be effectively prevented from flowing back in the feeding direction. Therefore, it is possible to achieve uniform and sufficient primary cooling.

Further, in the above-described description, a case in which shear deformation is applied to the hollow material Pm made of a metal with a rectangular cross section has been exemplified, but the present invention is not limited only to this aspect. That is, even when the cross-sectional shape of the hollow material made of a metal is a round pipe, a polygonal pipe, or a pipe with an arbitrary curved surface shape other than the rectangle, according to the embodiments, the satisfactory hollow bent part Pp can be similarly obtained.

The hollow bent part Pp manufactured by the manufacturing method including the cooling methods of the present embodiment and various modified examples is manufactured by performing heat treatment (for example, quenching) at the same time as the processing by the shearing force. Therefore, the hollow bent part Pp with a high-strength portion of, for example, 1470 MPa or more can be manufactured by simpler processes and with high processing accuracy compared to a hollow bent part that has been subjected to cold shearing and bending processing and then a heat treatment (for example, quenching).

The hollow bent part Pp manufactured by the manufacturing method including the cooling methods of the present embodiment and various modified examples can be applied to, for example, applications (i) to (vii) exemplified below.

(i) Structural members of automobile bodies such as, for example, front side members, cross members, side members, suspension members, roof members, A-pillar reinforcements, B-pillar reinforcements, or bumper reinforcements

(ii) Strength members or reinforcing members of automobiles such as, for example, seat frames or seat cross members

(iii) Parts of exhaust systems such as exhaust pipes of automobiles

(iv) Frames or cranks of bicycles or motorcycles

(v) Reinforcing members or bogie parts (bogie frames, various beams, and so on) of vehicles such as electric trains

(vi) Frame parts or reinforcing members of ship hulls and so on

(vii) Strength members, reinforcing members, or structural members for home appliances

The outline of the above-described embodiment including various modified examples will be summarized again below.

(1) As illustrated in FIG. 1, the cooling device 50 according to one aspect of the present invention is used for a hollow bent part manufacturing apparatus that includes a feeding mechanism that feeds the hollow material Pm made of a metal in the feeding direction (+X direction) which is a longitudinal direction thereof while supporting it at the first position A, the heating coil 12a that heats the hollow material Pm at the second position B downstream of the first position A, the cooling device 50 that cools the hollow material Pm by injection of the refrigerant at the third position C downstream of the second position B, and the arm (bending force applying part) that forms the bent portion Pb in the hollow material Pm by gripping the hollow material Pm at the fourth position D downstream of the third position C and moving the gripping position g in directions in two dimensions or directions in three dimensions.

As illustrated in FIG. 2, the cooling device 50 includes the first refrigerant injection device 51 and the second refrigerant injection device 52 which are the first cooling mechanism, and the third refrigerant injection device 53 which is the second cooling mechanism.

The first cooling mechanism includes the nozzle (first nozzle) 51a disposed to be aligned with the heating coil 12a on the downstream side when viewed in a first virtual plane (FIG. 2) including the extension line EX of the axis in the feeding direction of the hollow material Pm at the first position A and whose injection direction of the refrigerant is the first injection direction W1, the nozzle (second nozzle) 52a disposed to be aligned with the nozzle 51a on the downstream side when viewed in the first virtual plane and whose injection direction of the refrigerant is the second injection direction W2 intersecting the first injection direction W1, the valve (first valve) V1 selectively switching a supply destination of the refrigerant between one and the other of the nozzle 51a and the nozzle 52a, and the control device (first control unit) 15 controlling the valve V1.

The second cooling mechanism includes the nozzle (third nozzle) 53a disposed on a side opposite to the nozzle 51a and the nozzle 52a with the extension line EX sandwiched therebetween when viewed in the first virtual plane and whose injection direction of the refrigerant is the third injection direction W3 forming an angle of 20 degrees or more and 70 degrees or less with respect to the left side surface c that is the bent inner circumferential surface of the bent portion Pb.

(2) As illustrated in FIG. 7, the following configuration may be adopted in the above-described (1).

That is, the second cooling mechanism includes the part nozzle (first part nozzle) 153a1 and the part nozzle (second part nozzle) 153a2 constituting the third nozzle, the valve (second valve) V3 that selectively switches a supply destination of the refrigerant between one and the other of the part nozzle 153a1 and the part nozzle 153a2, and the control device (second control unit) 15 that controls the valve V3.

An injection direction of the refrigerant from the part nozzle 153a1 when viewed in the first virtual plane is 20 degrees or more and 70 degrees or less with respect to the extension line EX, and an injection direction of the refrigerant from the part nozzle 153a2 when viewed in the first virtual plane is the third injection direction W3.

(3) As illustrated in FIG. 8, in the above-described (1) or (2), the vertical cooling device (third cooling mechanism) 70 including the nozzles (fourth nozzles) 71a and 73a and the nozzles (fifth nozzles) 72a and 74a which are disposed on a second virtual plane perpendicular to the first virtual plane with the extension line EX as a line of intersection may be further provided.

Injection directions of the refrigerant of the nozzles 71a and 73a when viewed in the first virtual plane are the fourth injection directions W6 and W8 along the extension line EX. Injection directions of the refrigerant of the nozzles 72a and 74a when viewed in the first virtual plane are the fifth injection directions W7 and W9 that intersect the fourth injection directions W6 and W8.

(4) Similarly, as illustrated in FIG. 8, the following configuration may be adopted in the above-described (3).

That is, the third cooling mechanism may further include the valve (third valve) V2 that selectively switches a supply destination of the refrigerant between one and the other of the nozzles 71a and 73a and the nozzles 72a and 74a, and the control device (third control unit) 15 that controls the valve V2.

(5) As illustrated in FIG. 13, the following configuration may be adopted in any one of the above-described (1) to (4).

The cooling device (fourth cooling mechanism) 60 including the nozzles (sixth nozzles) 61a and 62a disposed on the second virtual plane perpendicular to the first virtual plane with the extension line EX as a line of intersection is further provided. Then, injection directions of the nozzles 61a and 62a when viewed in the first virtual plane are the fourth direction W4 and the fifth direction W5 (sixth injection directions) which form an angle of approximately ½ of the shear angle θ of the bent portion Pb with respect to the feeding direction.

(6) As illustrated in FIG. 1, the cooling method according to one aspect of the present invention is used for a manufacturing method of the hollow bent part Pp including a process of feeding the hollow material Pm made of a metal in the feeding direction (+X direction) which is a longitudinal direction thereof while supporting it at the first position A, a process of heating the hollow material Pm at the second position B downstream of the first position A, a process of cooling the hollow material Pm by injection of the refrigerant at the third position C downstream of the second position B, and a process of forming the bent portion Pb in the hollow material Pm by gripping the hollow material Pm at the fourth position D downstream of the third position C and moving the gripping position g in directions in two dimensions or directions in three dimensions.

Further, the cooling method includes a first cooling process and a second cooling process.

As illustrated in FIG. 2, the first cooling process includes a first process of injecting the refrigerant from the third position C in the first injection direction W1 when viewed in the first virtual plane including the extension line EX of the axis CL in the feeding direction of the hollow material Pm at the first position A, a second process of injecting the refrigerant from the third position C in the second injection direction W2 intersecting the first injection direction W1 when viewed in the first virtual plane, and a third process in which the second process is stopped when the first process is performed and the first process is stopped when the second process is performed.

Then, in the second cooling process, the refrigerant is injected from the third position C in the third injection direction W3 which forms an angle of 20 degrees or more and 70 degrees or less with respect to the left side surface c which is the bent inner circumferential surface of the bent portion Pb when viewed in the first virtual plane.

(7) As illustrated in FIG. 7, the following process may be adopted in the above-described (6).

That is, the second cooling process includes a fourth process of injecting the refrigerant in an injection direction of 20 degrees or more and 70 degrees or less with respect to the extension line EX when viewed in the first virtual plane, a fifth process of injecting the refrigerant in the third injection direction W3 when viewed in the first virtual plane, and a sixth process in which the fifth process is stopped when the fourth process is performed and the fourth process is stopped when the fifth process is performed.

(8) As illustrated in FIG. 8, the following process may be adopted in the above-described (6) or the (7).

That is, the cooling method further includes a third cooling process of injecting the refrigerant toward the hollow material Pm from the fourth injection directions W6 and W8 and the fifth injection directions W7 and W9 in the second virtual plane perpendicular to the first virtual plane with the extension line EX as a line of intersection.

The third cooling process includes a seventh process of injecting the refrigerant in the fourth injection directions W6 and W8 along the extension line EX when viewed in the first virtual plane illustrated in FIG. 9, and an eighth process of injecting the refrigerant in the fifth injection directions W7 and W9 intersecting the fourth injection directions W6 and W8 when viewed in the first virtual plane.

(9) As illustrated in FIG. 8, the following process may be adopted in the above-described (8).

The third cooling process further includes a ninth process in which the eighth process is stopped when the seventh process is performed and the seventh process is stopped when the eighth process is performed.

(10) As illustrated in FIG. 13, the following process may be adopted in any one of the above-described (6) to (9).

That is, the cooling method further includes a fourth cooling process of injecting the refrigerant toward the hollow material Pm in the second virtual plane perpendicular to the first virtual plane with the extension line EX as a line of intersection.

The fourth cooling process includes a tenth process of injecting the refrigerant in the sixth injection direction W4 in which an angle formed by an injection direction of the refrigerant with respect to the feeding direction is approximately ½ of the shear angle θ of the bent portion Pb when viewed in the first virtual plane.

### INDUSTRIAL APPLICABILITY

According to the cooling device and the cooling method of the present invention, it is possible to secure a collision pressure of the refrigerant to obtain a sufficient cooling capacity and achieve uniform cooling in which non-uniformity of hardness in a circumferential direction of the product is curbed even when obtaining a hollow bent part having a bent portion with an extremely small bending radius.

### BRIEF DESCRIPTION OF THE REFERENCE SYMBOLS

10 Manufacturing apparatus (hollow bent part manufacturing apparatus)
12a Heating coil
15 Control device (first control unit, second control unit, third control unit)
50 Cooling device
51 First refrigerant injection device (first cooling mechanism)
51a Nozzle (first nozzle)
52 Second refrigerant injection device (first cooling mechanism)
52a Nozzle (second nozzle)
53 Third refrigerant injection device (second cooling mechanism)
53a Nozzle (third nozzle)
60 Vertical cooling device (fourth cooling mechanism)
61a, 62a Nozzle (sixth nozzle)
70 Vertical cooling device (third cooling mechanism)
71a, 73a Nozzle (fourth nozzle)
72a, 74a Nozzle (fifth nozzle)
153a1 Part nozzle (first part nozzle)
153a2 Part nozzle (second part nozzle)
170 Vertical cooling device (third cooling mechanism)
A First position
B Second position
C Third position
c Left side surface (bent inner circumferential surface)
D Fourth position
EX Extension line
F Arrow (feeding direction)
g Gripping position
Pb Bent portion
Pm Hollow material
V1 Valve (first valve)
V2 Valve (third valve)
V3 Valve (second valve)
W1 First injection direction
W2 Second injection direction
W3 Third injection direction
W6, W8 Fourth injection direction
W7, W9 Fifth injection direction

1. A cooling device which is used for a hollow bent part manufacturing apparatus including:
a feeding mechanism feeding a hollow material made of a metal in a feeding direction which is a longitudinal direction thereof while supporting the hollow material at a first position;
a heating coil heating the hollow material at a second position downstream of the first position;
a cooling device cooling the hollow material by injection of a refrigerant at a third position downstream of the second position; and
a bending force applying part forming a bent portion in the hollow material by gripping the hollow material at a fourth position downstream of the third position and moving a gripping position in directions in two dimensions or directions in three dimensions,
the cooling device comprising a first cooling mechanism and a second cooling mechanism, wherein
the first cooling mechanism includes:
a first nozzle disposed to be aligned with the heating coil on a downstream side when viewed in a first virtual plane including an extension line of an axis in the feeding direction of the hollow material at the first position and whose injection direction of the refrigerant is a first injection direction;
a second nozzle disposed to be aligned with the first nozzle on a downstream side when viewed in the first virtual plane and whose injection direction of the refrigerant is a second injection direction intersecting the first injection direction;
a first valve selectively switching a supply destination of the refrigerant between one and the other of the first nozzle and the second nozzle; and
a first control unit controlling the first valve, and
the second cooling mechanism includes a third nozzle disposed on a side opposite to the first nozzle and the second nozzle with the extension line sandwiched therebetween when viewed in the first virtual plane and whose injection direction of the refrigerant is a third injection direction forming an angle of 20 degrees or more and 70 degrees or less with respect to a bent inner circumferential surface of the bent portion.

2. The cooling device according to claim 1, wherein
the second cooling mechanism includes:
a first part nozzle and a second part nozzle constituting the third nozzle;
a second valve which selectively switches a supply destination of the refrigerant between one and the other of the first part nozzle and the second part nozzle; and
a second control unit which controls the second valve,
an injection direction of the refrigerant from the first part nozzle when viewed in the first virtual plane is 20 degrees or more and 70 degrees or less with respect to the extension line, and
an injection direction of the refrigerant from the second part nozzle when viewed in the first virtual plane is the third injection direction.

3. The cooling device according to claim 1, further comprising a third cooling mechanism including a fourth nozzle and a fifth nozzle which are disposed on a second virtual plane perpendicular to the first virtual plane with the extension line as a line of intersection, wherein
an injection direction of the refrigerant of the fourth nozzle when viewed in the first virtual plane is a fourth injection direction along the extension line, and
an injection direction of the refrigerant of the fifth nozzle when viewed in the first virtual plane is a fifth injection direction which intersects the fourth injection direction.

4. The cooling device according to claim 3, wherein the third cooling mechanism further includes:
a third valve which selectively switches a supply destination of the refrigerant between one and the other of the fourth nozzle and the fifth nozzle; and
a third control unit which controls the third valve.

5. The cooling device according to claim 1, further comprising a fourth cooling mechanism which includes a sixth nozzle disposed on the second virtual plane perpendicular to the first virtual plane with the extension line as a line of intersection, wherein
an injection direction of the sixth nozzle when viewed in the first virtual plane is a sixth injection direction which forms an angle of approximately ½ of a shear angle θ of the bent portion with respect to the feeding direction.

6. A cooling method which is used for a manufacturing method of a hollow bent part including:
a process of feeding a hollow material made of a metal in a feeding direction which is a longitudinal direction thereof while supporting the hollow material at a first position;
a process of heating the hollow material at a second position downstream of the first position;
a process of cooling the hollow material by injection of a refrigerant at a third position downstream of the second position; and
a process of forming a bent portion in the hollow material by gripping the hollow material at a fourth position downstream of the third position and moving a gripping position in directions in two dimensions or directions in three dimensions,
the cooling method comprising a first cooling process and a second cooling process, wherein
the first cooling process includes:
a first process of injecting the refrigerant from the third position in a first injection direction when viewed in a first virtual plane including an extension line of an axis in the feeding direction of the hollow material at the first position;
a second process of injecting the refrigerant from the third position in a second injection direction intersecting the first injection direction when viewed in the first virtual plane; and
a third process in which the second process is stopped when the first process is performed and the first process is stopped when the second process is performed, and,
in the second cooling process, the refrigerant is injected from the third position in a third injection direction forming an angle of 20 degrees or more and 70 degrees or less with respect to a bent inner circumferential surface of the bent portion when viewed in the first virtual plane.

7. The cooling method according to claim 6, wherein the second cooling process includes:
a fourth process of injecting the refrigerant in an injection direction of 20 degrees or more and 70 degrees or less with respect to the extension line when viewed in the first virtual plane;
a fifth process of injecting the refrigerant in the third injection direction when viewed in the first virtual plane; and
a sixth process in which the fifth process is stopped when the fourth process is performed and the fourth process is stopped when the fifth process is performed.

8. The cooling method according to claim 6, further comprising a third cooling process of injecting the refrigerant toward the hollow material from a fourth injection direction and a fifth injection direction in a second virtual plane perpendicular to the first virtual plane with the extension line as a line of intersection, wherein
the third cooling process includes:
a seventh process of injecting the refrigerant in the fourth injection direction along the extension line when viewed in the first virtual plane; and
an eighth process of injecting the refrigerant in the fifth injection direction intersecting the fourth injection direction when viewed in the first virtual plane.

9. The cooling method according to claim 8, wherein the third cooling process further includes a ninth process in which the eighth process is stopped when the seventh process is performed and the seventh process is stopped when the eighth process is performed.

10. The cooling method according to claim 6, further comprising a fourth cooling process of injecting the refrigerant toward the hollow material in the second virtual plane perpendicular to the first virtual plane with the extension line as a line of intersection, wherein
the fourth cooling process includes a tenth process of injecting the refrigerant in a sixth injection direction in which an angle formed by an injection direction of the refrigerant with respect to the feeding direction when viewed in the first virtual plane is approximately ½ of a shear angle θ of the bent portion.
